(19) United States
(12) Patent Application Publication
(10) Pub. No.: US 2023/0203676 A1
(43) Pub. Date: Jun. 29, 2023

(54) ALTERNATING CURRENT ELECTROCATALYTIC DRY HYDROGEN PEROXIDE GENERATING DEVICES AND METHODS OF USE THEREOF

(71) Applicant: SYNEXIS LLC, Lenexa, KS (US)

(72) Inventors: James D. LEE, Lenexa, KS (US); Zachary N. MARTIN, Lenexa, KS (US); Kristopher RANES, Lenexa, KS (US); David SCHUT, Lenexa, KS (US)

(21) Appl. No.: 17/996,179

(22) PCT Filed: Apr. 14, 2021
(86) PCT No.: PCT/US2021/027332

§ 371 Date: Oct. 13, 2022

Related U.S. Application Data
(60) Provisional application No. 63/010,659, filed on Apr. 15, 2020.

(51) Int. Cl. C25B 1/30; C25B 11/032; C25B 11/056; C25B 11/091; C25B 15/02; C25B 9/65; C01B 15/017

(52) U.S. Cl. CPC C25B 1/30; C25B 11/032; C25B 11/056; C25B 11/091; C25B 15/02; C25B 9/65; C01B 15/017

(57) ABSTRACT

The present disclosure provides for and includes electrocatalytic devices and methods for the production of Dry Hydrogen Peroxide (DHP), a non-hydrated, gaseous form of hydrogen peroxide.

### CROSS-REFERENCE TO RELATED APPLICATIONS

This application claims priority from U.S. Provisional Patent Application No. 63/010,659, filed Apr. 15, 2020, which is herein incorporated by reference in its entirety.

### FIELD OF THE INVENTION

The present disclosure relates to methods and devices for the electrolytic production of Dry Hydrogen Peroxide (DHP) gas using alternating and switched current power modes.

### BACKGROUND OF THE INVENTION

A number of U.S. patents describe Dry Hydrogen Peroxide (DHP) gas. DHP was first described in United States Patent Publication No. US 2009/0041617 published Feb. 12, 2009 (“the '617 Publication”). The '617 publication discloses the photocatalytic production of DHP using a flow of ambient air through an air permeable catalyst coated mesh, termed a “sail.” Under operation, the absorption of photons at certain catalyst defined wavelengths generates a reactive ionized region called a “plasma” at the catalyst's surface. Plasmas consist of positive ions and free electrons as well as hydroxyl radicals, hydroxyl ions, superoxides, ozone ions, hydrogen peroxide, and hydrogen ions. These components are prepared in situ on the surface of the illuminated catalyst from the oxygen and water present in ambient air. By flowing ambient air through the air permeable substrate, components of the plasma are removed and directed away from the catalytic surface. Thus, the flow of air removes the reactive species before they can be consumed. Away from the device, nearly all of the reactive species are consumed or degraded, leaving the relatively stable hydrogen peroxide to persist and accumulate in the area outside the device. In contrast to prior art photocatalytic air purifiers, DHP generating devices are designed to prepare hydrogen peroxide gas and direct it outside of the device and into the surrounding environment. In an enclosed environment, DHP produced by the devices accumulates and acts in a continuous manner to control microbes. The '617 Publication first demonstrated the production of DHP using a photocatalytic device and demonstrated its effectiveness on the growth and survival of bacteria, fungi, and viruses.

In International Patent Application No. PCT/US2019/055935, filed Oct. 11, 2019, by Lee et al., it is shown for the first time that DHP can be produced using an electrolytic approach (also referred to as electrocatalytic production). In the electrocatalytic reaction an air-permeable structure (called a “sail”) is powered with an electric potential while humid air is passed through. A catalyst present on the sail is activated by the potential difference and generates a hole which oxidizes water to produce a hydroxyl radical, or alternatively, forces occupation of the lowest molecular orbital (LUMO or conduction band) which can then reduce oxygen The present disclosure provides improved methods for the electrocatalytic generation of DHP by controlling the polarity of the electric potential by varying the waveform. The devices disclosed provide for a solid-state method of generating DHP that is scalable and can be operated at greatly improved efficiency with low power. It further provides for increased efficiency and capacity as electrocatalytic mesh (ECM) sails can comprise activated catalysts nearly all the time.

### SUMMARY OF THE INVENTION

The present disclosure provides for, and includes, an electrocatalytic device for the production of dry hydrogen peroxide (DHP) comprising an electrocatalytic mesh comprising an air permeable electrically conductive network coated with a catalyst, an electrical power source including a variable waveform generator.

The present disclosure provides for, and includes, an electrocatalytic device for the production of dry hydrogen peroxide (DHP) comprising an electrocatalytic mesh (ECM) comprising an air permeable electrically conductive network coated with a catalyst, an electrical power source including a variable waveform generator wherein said variable waveform generator is configured to provide a wave having a minimum voltage of ±0.3 V, a maximum voltage of 30 kilovolts (KV), and a frequency between 0.00025 Hertz (Hz) and 5 gigahertz (GHz).

The present disclosure provides for, and includes, a method of preparing a dry hydrogen peroxide (DHP) gas containing environment using an electrocatalytic device comprising providing an electrocatalytic device comprising an electrocatalytic mesh (ECM) comprising an air permeable electrically conductive network coated with a catalyst and an electrical power source including a variable waveform generator; providing a time varied electric potential to said ECM, wherein said time varied electric potential has a waveform selected from the group consisting of sine wave, square wave, triangle wave, and a sawtooth wave; providing a flow of humid air through said ECM having a time varied electric potential to prepare a DHP containing airflow; directing said DHP containing airflow into an enclosed environment.

The present disclosure provides for, and includes, a method of preparing a dry hydrogen peroxide (DHP) gas containing environment using an electrocatalytic device comprising providing an electrocatalytic device comprising an electrocatalytic mesh (ECM) comprising an air permeable electrically conductive network coated with a catalyst and an electrical power source including a variable waveform generator; providing a time varied electric potential to said ECM, wherein said time varied electric potential has a waveform selected from the group consisting of sine wave, square wave, triangle wave, and a sawtooth wave; providing a flow of humid air through said ECM having a time varied electric potential to prepare a DHP containing airflow; directing said DHP containing airflow into an enclosed environment, wherein said time varied electrical potential has a minimum voltage of ±0.3 V, a maximum voltage of ±30 kilovolts (KV), and a frequency between 0.00025 Hertz (Hz) and 0.5 gigahertz (GHz), and wherein the current is between 0.01 Amp (A) and 100 A.

### BRIEF DESCRIPTION OF THE DRAWINGS

The present disclosure is disclosed with reference to the accompanying drawings, wherein:

FIG. 1 is a plot of the levels of DHP in parts-per-billion versus time during the use of a DC powered electrocatalytic device comprising an electrocatalytic mesh (ECM) in a DHP device of the present disclosure.

FIG. 2A to 2D presents alternating current waveforms suitable for powering electrocatalytic devices of the present disclosure. FIG. 2A provides a sine wave waveform. FIG. 2B provides a square wave waveform. FIG. 2C provides a triangle waveform. FIG. 2D provides a sawtooth waveform.

FIG. 3 presents a schematic illustrating the dimensions of the electrocatalytic meshes of the present disclosure.

FIGS. 4A and 4B illustrates an electrocatalytic mesh (ECM) 100 according to an embodiment of the present disclosure. FIG. 4A presents ECM 100 comprising electrically conductive network 110 formed from coated conductors 120 held in a frame 150, said frame 150 having electrical connectors. FIG. 4B presents a diagram of a cross-section of a coated conductor 120 having a conductive solid or hollow-core material 125, an optional adhesive layer 130, and a catalytic layer 135 (layers not drawn to scale).

FIG. 5 illustrates the preparation of an ECM according to an aspect of the present disclosure. A conductive mesh layer 125, for example stainless steel or nickel, is coated with an electrocatalyst 135 such as TiO₂, WO₃, CeO₂, ZnO, directly on the conductive layers.

FIG. 6 illustrates the preparation of the ECM according to an aspect of the present disclosure. Conductive layer 125 is first coated with an adhesive layer 130 and the electrocatalyst layer 135 is deposited.

FIG. 7 illustrates the preparation of an ECM according to an aspect of the present disclosure. Conductive layer 125, such as silver (Ag) or copper (Cu) is coated with a second, conductive layer 126, for example, nickel (Ni) or chromium (Cr) deposited by electroplating (e.g., Ni, Cr) or electroless plating (Ni). The electrocatalyst 135 is then deposited on the conductive layer 126.

FIG. 8 illustrates the preparation of an ECM according to an aspect of the present disclosure. Conductive layer 125, such as silver (Ag) or copper (Cu) is coated with a second, conductive layer 126 as shown in FIG. 7 and then further coated with an adhesive or coupling layer comprising, for example a silane coupling agent (SCA). The electrocatalyst 135 is then deposited and covalently bonded to the SCA

Not to be limited, any combination of mesh substrate, conductive layer, and catalytic layer is suitable for preparing the ECM of the present specification. The active conductive layer and catalytic layers can have adhesive layers or coupling layers separating them without affecting the scope or activity of the ECM.

Corresponding reference characters indicate corresponding parts throughout the several views. The examples set out herein illustrate several embodiments of the present disclosure but should not be construed as limiting the scope of the present disclosure in any manner.

### DETAILED DESCRIPTION

Before explaining aspects of the invention in detail, it is to be understood that the invention is not necessarily limited in its application to the details set forth in the following description or exemplified by the Examples. The invention is capable of other aspects or of being practiced or carried out in various ways.

The present disclosure provides for, and includes devices for producing Dry Hydrogen Peroxide (DHP) or alternatively “dilute hydrogen peroxide.” DHP has been identified as “purified hydrogen peroxide gas” (PHPG). As used herein, DHP is equivalent to PHPG as used in the art. DHP is a non-hydrated gaseous form of H₂O₂ that is distinct from liquid forms of hydrogen peroxide, including hydrated aerosols and vaporized hydrogen peroxide (VHP) that are generated by the atomization or heating of aqueous solutions of hydrogen peroxide. DHP is generated in situ from the oxidation of ambient water vapor or through the reduction of oxygen and cannot be produced from a solution of hydrogen peroxide. Vaporized or atomized forms of hydrogen peroxide necessarily comprise hydrogen peroxide associated with water and are hydrated. These hydrated hydrogen peroxide molecules are surrounded by water molecules bonded by electrostatic attraction and London Forces. Thus, the ability of the hydrogen peroxide molecules to directly interact with the environment by electrostatic means is greatly attenuated by the bonded molecular water, which effectively alters the fundamental electrostatic configuration of the encapsulated hydrogen peroxide molecule.

Aerosolized and vaporized forms of hydrogen peroxide solution have significantly higher concentrations of H₂O₂, typically comprising greater than 1×10⁶ molecules per cubic micron compared to air containing DHP that contains between 0.25 and 2.5 molecules per cubic micron (at 10 parts-per billion (ppb) and 100 ppb respectively). Hydrogen peroxide aerosols and vapors are prepared from aqueous solutions of hydrogen peroxide and also differ from DHP as the aerosols are hydrated and, regardless of the size of the droplet, settle under the force of gravity. Vaporized forms condense and settle. Aerosolized forms of hydrogen peroxide are effective antimicrobial agents; however, they are generally considered toxic and wholly unsuitable for use in occupied spaces. See for example, Kahnert et al., “Decontamination with vaporized hydrogen peroxide is effective against Mycobacterium tuberculosis,” Lett. Appl. Microbiol. 40(6):448-52 (2005). The application of vaporized hydrogen peroxide has been limited by concerns of explosive vapors, hazardous reactions, corrosivity, and worker safety. See Agalloco et al., “Overcoming Limitations of Vaporized Hydrogen Peroxide,” Pharmaceutical Technology, 37(9):1-7 (2013). Further, spaces treated with aerosolized forms, typically at concentrations of between 150 and 700 ppm, remain unsuitable for occupation until the H₂O₂ has been reduced by degradation to water and oxygen and the H₂O₂. The use of DHP solves the problem of toxicity of aerosolized H₂O₂ (e.g., vaporized and liquid forms of H₂O₂) and can provide continuous safe antimicrobial and oxidative activity.

DHP is non-hydrated and behaves essentially as an ideal gas. In this form, DHP behaves largely as an ideal gas and is capable of diffusing freely throughout an environment to attain an average concentration of about 25 molecules per cubic micron of air when present at 1 ppm. More typically, DHP is provided and maintained between 0.5 ppb and 8.0 ppb (as measured by the Picarro PI2115 H₂O₂ Sensor). As a gas, DHP is capable of penetrating most porous materials, essentially diffusing freely to occupy any space that is not airtight. The gaseous form of hydrogen peroxide doesn't settle, deposit, or condense when present at concentrations of at least up to 10 ppm. DHP is completely “green” and leaves no residue as it breaks down to water and oxygen. DHP is formed free of organic species. DHP cannot be prepared from an aqueous solution even if the vaporized form is a so-called “dried” form.

DHP can be produced by two pathways, an oxidative pathway starting from water, and a reductive pathway starting from oxygen. Hydrogen ions and hydroxyl radicals can be produced from water by the following standard reaction:

2H₂O→2H⁺+2e⁻+2OH·→H₂O₂+2H⁺+2e⁻ Oxidation

As hydroxyl radicals build-up they combine to form hydrogen peroxide. The reductive pathway reacts ambient oxygen with hydrogen ions and electrons to produce hydrogen peroxide.

O₂+2H⁺+2e⁻→H₂O₂ Reduction

When coupled, a total of two hydrogen peroxide molecules are produced from two molecules of water and one molecule of oxygen:

2H₂O+O₂→2H₂O₂ Combined Reaction:

Initially, it was shown that DHP could be produced by a photocatalytic process using devices having a source of ultraviolet light, a metal or metal oxide photocatalyst (e.g., TiO₂), a catalyst substrate structure; and an air distribution mechanism arranged in a morphology that enables the removal of hydrogen peroxide from the reactor before it is reduced back to water. See U.S. Pat. No. 8,168,122, issued May 1, 2012, to Lee. Not to be limited by theory, it is understood that by removing the hydrogen peroxide, the reaction equilibrium of the catalyst is modified so that the photocatalyst preferentially reduces oxygen, rather than hydrogen peroxide, such that it produces hydrogen peroxide from both the oxidation of water and from the reduction of dioxygen. Using morphology that permits immediate removal of hydrogen peroxide gas before it can be reduced, DHP may be generated in any suitable process that simultaneously oxidizes water in gas form and reduces oxygen gas.

Most recently, it was demonstrated that DHP could be produced using an electrocatalytic reactor. See International Patent Application No. PCT/US2019/055935, filed Oct. 11, 2019, and claiming priority to U.S. Provisional Application No. 62/745,131, filed Oct. 12, 2018. Like photocatalytic production, a purpose-designed morphology that enables the removal of near-ideal gas phase hydrogen peroxide from the reactor before it is forced to undergo subsequent reduction or oxidation. Without intending to be limited, in operation, hydrogen peroxide gas may be produced at a greatly accelerated rate compared to photocatalytic methods. Also, not to be limited by theory, it is thought that the electrolytic process is not subject to limitations caused by low humidity, by the comparatively slow rate at which humidity is absorbed onto the photocatalyst, or by airborne contaminants such as nitrogen oxides that interfere with the photocatalytic reaction. Accordingly, it is thought that by controlling the electrical potential, or voltage applied, the rate of production of near-ideal hydrogen peroxide gas can be readily regulated or optimized for use in a given space or application, and controlled to provide concentrations down to the limits of detection (e.g., about 1 ppb) or as high as seven or more parts per million Finally and notably, the intended uses and methods of use of the photocatalytic and electrocatalytic devices are not achieved as a result of the electrocatalytic or photocatalytic processes, but by the effects of near-ideal DHP gas once it is released into the environment.

Photocatalytic and electrocatalytic devices share a common morphology that provides for the removal of the hydrogen peroxide from the reaction surface before it can be reduced back to water and oxygen. In both types of devices, when in operation, a flow of humid air is provided by an air distribution mechanism that directs airflow through the catalytic surface, typically a mesh coated with a catalyst, and directs the DHP produced away from the catalytic surface and into the environment. Two types of devices have been demonstrated, a stand-alone device that incorporates a fan (e.g., air distribution mechanism) into an enclosure and a device intended for heating, ventilating, and air conditioning (HVAC) system that provides a catalytic surface and power source and relies on the HVAC system to provide a flow of air and to direct the DHP into the environment. For photocatalytic systems, the power source is an ultraviolet (UV) light that illuminates the catalytic surface. Preferably, the UV light has a wavelength above 181 nanometers (nm) to avoid the production of ozone which can oxidize hydrogen peroxide and reduce efficiency and is a known to be toxic when present at high concentration. Ozone is regulated by both the Food and Drug Administration (FDA) and the Occupational Safety and Health Administration (OSHA). The FDA requires the ozone output of indoor medical devices to be no more than 0.05 ppm of ozone. OSHA requires that workers not be exposed to an average concentration of more than 0.10 ppm of ozone for 8 hours. For electrocatalytic systems, the power source is an electric potential applied to an electrically conductive network that is coated with a catalyst to prepare an electrocatalytic mesh (ECM). When provided with a suitable voltage and a flow of humid air, DHP is produced and directed away from the catalytic surface.

The conductive network can be directly conductive, such as a copper mesh, or can be indirectly conductive such as a non-conductive material that is coated with a conductive material, for example, a polypropylene mesh coated with a metal such as nickel. Also included, and provided for, are ECMs having intermediate adhesive layers that covalently bond the electrocatalyst to an electrically conductive substrate. Also included are adhesive layers that bond conductive substrates to non-conductive substrates. The use of conductive layers, catalysis layers, and adhesive layers are well known in the semiconductor industry. As would be evident to a person of skill, a number of the catalysts of the present disclosure are themselves semiconductors (e.g., titanium dioxide, zinc oxide, the titanates).

Using morphology that permits immediate removal of hydrogen peroxide gas before it can be reduced, near-ideal gas hydrogen peroxide may be generated in any suitable manner known in the art, including but not limited to, any suitable process known in the art that simultaneously oxidizes water (or another compound that can provide hydrogen ions separable by osmosis) in liquid or gas form, and reduces oxygen gas, including gas-phase photo-catalysis, e.g., using a metal catalyst such as titanium dioxide, zinc oxide, titanium dioxide doped with co-catalysts (such as copper, rhodium, silver, platinum, gold, etc.), or other suitable metal oxide photocatalysts. Near-ideal gas hydrogen peroxide may also be produced by electrolytic processes using anodes and cathodes made from any suitable metal or constructed from metal oxide ceramics using morphology that permits immediate removal of hydrogen peroxide gas before it can be reduced.

Continuously produced via a hydrogen peroxide diffuser device an equilibrium concentration of about 5.0 parts per billion of near-ideal gas phase hydrogen peroxide may be achieved and maintained continuously in an environment. At equilibrium at one atmosphere pressure and 19.51 degrees Celsius, near-ideal gas phase hydrogen peroxide will be present in every cubic micron of air at an average amount of one molecule per cubic micron for every 0.04 parts per million of concentration. At one part per million, the average number of hydrogen peroxide molecules per cubic micron will be 25, and at seven parts per million, it will be 175. As used herein, DHP comprises gaseous hydrogen peroxide (H₂O₂) that is substantially free of hydration, ozone, plasma species, or organic species.

As used herein, the term “free of ozone” means an amount of ozone below about 0.015 ppm ozone. In an aspect, “free of ozone” means that the amount of ozone produced by the device is below or near the level of detection (LOD) using conventional detection means. Ozone detectors are known in the art and have detection thresholds in the parts per billion using point ionization detection. A suitable ozone detector is the Honeywell Analytics Midas® gas detector capable of detecting 0.036 to 0.7 ppm ozone. Another instrument with greater sensitivity is the Serinus 10 Ozone Analyzer (Acoem Ecotech, Melbourne Australia) which has an lower detection limit (LDL) of <0.5 ppb.

As used herein, “free of hydration” means that the hydrogen peroxide gas is at least 99% free of water molecules bonded by electrostatic attraction and London Forces. Hydrated forms of hydrogen peroxide are produced by evaporation and atomization of aqueous hydrogen peroxide (AHP). Aerosols and vapors produced from AHP are a hydrated form of hydrogen peroxide having each molecule surrounded by a shell of water molecules (hydration shell) bonded by electrostatic attraction and London Forces. While there are various “drying” methods, such methods cannot remove the hydration shell.

Also as used herein, a DHP that is free of plasma species means hydrogen peroxide gas that is at least 99% free of hydroxide ion, hydroxide radical, hydronium ion, hydrogen radical, and combinations thereof.

The present specification reports the production of DHP using an electrolytic process. The fundamental nature of an electrolytic process is to create a flow of electrons from one set of chemical reactants to another, thereby inducing paired oxidation and reduction reactions to produce products. This occurs when an electrical potential, or voltage, is supplied between two electrodes, each of which is exposed to reactants. The reaction can be controlled by optimizing the voltage to provide products at the desired rate, modifying the catalytic substrate (e.g., selecting catalyst, co-catalyst, additive), modifying the conductive network, and adjusting the air flow, including adjusting the humidity. As provided herein, the reaction can be further controlled and optimized by varying the potential and polarity of the power source.

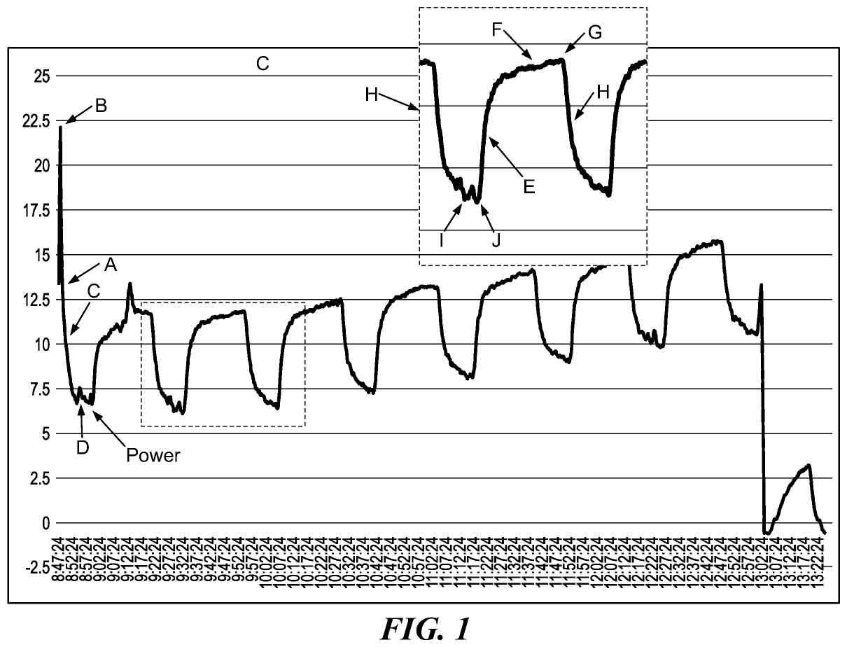

The production of DHP using a direct-current (DC) electrolytic process is shown in FIG. 1. A plot of the level of DHP detected is plotted versus time on a TiO₂ coated mess copper mesh, with an estimated coverage area of about 5%. The relative humidity is maintained between 68% to 70% and the temperature is 75° C. The test is initiated by the removal of a C-12 filter from the DHP detecting device (Interscan) (A) which results in a pressure spike (B) which decays (C) to the background (D). The sail is powered by connection to a 9V battery (arrow) and DHP is detected and the level rises (E). After a period, production of DHP plateaus (F) for a time before forced shift (G) occurs that results in decreasing levels of DHP (H) until DHP reaches a minima (J) before a second forces shift occurs and DHP levels rise again (E). The cycle is then repeated, oscillating between the production of a slightly increasing maximum (F) and minimum (I) due to drift in the Interscan detector. At the plateau, DHP levels are measured about 5 ppb above the minima (DHP levels are measured using the Interscan 4000 Series hydrogen peroxide sensor).

Not to be limited by theory, during electrocatalytic production of DHP using a DC potential, only one half-reaction dominates at a time. In one mode (cathodic phase), cathodic oxidation occurs generating hydroxyl ions which combine to form DHP. The DHP level rises (E) and peaks (F), maintaining a level of about 5 ppb DHP. A forced shift (G) occurs, and the device enters a second mode (the “anodic phase”). During the anodic phase, the DHP level drops (H) and reaches a minimum (I). During the anodic phase, it is thought that anodic reduction takes place wherein H⁺ that was produced during the cathodic phase combines with oxygen to produce DHP. Side reactions can consume DHP and these are thought to predominate when DHP is present. During the anodic phase, DHP production is exceeded by the destruction of existing DHP.

Electrocatalytic devices have two primary modes of operation: Cathodic and Anodic. Not to be limited by theory, electrocatalytic devices operates as follows.

Cathodic operation is achieved when a potential is applied to remove electrons (e⁻) from the catalyst. As this occurs, holes (h⁺) develop in the catalyst and migrate to active sites throughout the catalyst.

The holes behave unlike those developed in photocatalysis. In photocatalysis, electrons are promoted to higher energy states by photons to generate an electron-hole pair, where the vast majority simply decay through either radiative recombination (generating light) or nonradiative recombination (generating heat) to the ground state. Relatively few electron-hole pairs in a photocatalyst perform their intended function by capturing an electron from a water molecule (obtained from humidity in ambient air) occupying an active site, oxidizing it into a hydroxyl radical and releasing a proton (H⁺) in the process.

In electrocatalytic devices, however, the holes are held open until a water molecule (or other oxidizable species) occupies the active site. When this occurs, the hole captures an electron from the water molecule, producing a hydroxyl radical and a proton, as noted above.

Neutrally charged, and relatively large hydroxyl radicals are separated from the electrocatalyst by an airflow. The comparatively small and positive-charged protons are retained on the catalyst by electrostatic attraction to valence electrons in oxygen molecules on the catalyst. Operating airflows are selected that are strong enough to separate the hydroxyl radicals from the electrocatalyst, yet are too weak to separate the protons from the electrocatalyst. This process is referred to as plasma refinement or plasma separation. Hydroxyl radicals combine downstream of the electrocatalyst in the absence of free electrons and protons, allowing them to form DHP Gas.

The beneficial difference between photocatalytic and electrocatalytic systems is that even the crudest proof of concept electrocatalytic device demonstrated an efficiency fifty times greater than observed in photocatalytic devices. This is believed to be due to a combination of reasons that should not be construed to be limiting.

First, the cathodic potential applied to the electrocatalyst draws as many electrons from the catalyst as the applied potential permits. Higher potentials can draw more. As a great many electrons are drawn from the electrocatalyst, a great many holes are simultaneously formed. Theoretically, an electrocatalyst becomes “saturated” with holes when each active site has an electron removed.

Second, with no excited state electrons lingering on the electrocatalyst to potentially fill the holes, the holes remain open indefinitely until a water molecule occupies the active site and is subsequently oxidized.

Third, once a hole has been filled by oxidizing a water molecule, it can be immediately regenerated by the applied potential.

Fourth, it is believed that the adsorption of water molecules is normally the limiting factor in photocatalysis, where a successful water molecule oxidation is dependent on a water molecule already being adsorbed at an active site. It is statistically rare for a water molecule to slip into an unoccupied active site occupied by a photo-catalytically generated electron-hole pair due to its very short lifespan. In fact, photo-catalytically generated electron-hole pairs will instead preferentially migrate to active sites where water molecules are already adsorbed to the extent that they are available. By contrast, water molecule adsorption is enhanced in a cathodically active electrocatalyst. Because there are a great many holes, and because they are held open indefinitely, water molecules have an extended timeframe within which to occupy a site with a hole. Further, water molecules are polar, and holes are positively charged. This means that water molecules will be more strongly attracted to holes carrying a full positive charge than they are to the partial positive charge (due to simple charge separate across the metal-oxygen bond) of a metal atom at the active site. This results in more effective water molecule adsorption rates, more effective water molecule oxidation rates, and more effective water molecule replacement as oxidations occur and free up active sites again.

It is believed that the limiting factor for cathodic water molecule oxidation is the by-production, and build-up of, protons on the electrocatalyst. This creates an increasingly positive overall static charge on the electrocatalyst that will eventually mount to a point where it will counteract the applied cathodic potential and shut down the cathodic oxidation of water molecules.

The basic chemical equations applying to cathodic electrocatalytic operation are these:
1. Applied Cathodic Potential+Electrocatalyst→e⁻ (removed from the electrocatalyst)+h⁺ (migrates to active site)
2. h⁺+H₂O→OH·+H⁺
3. 2OH·→H₂O₂

At some point, either when or before the mounting accumulation of protons shuts down cathodic action, the electrocatalyst is shifted to an applied anodic potential.

In anodic mode a rich supply of protons are present on the catalyst and free electrons are supplied directly to the electrocatalyst. The third necessary component is a reducible species; in this case, molecular oxygen, which is in great surplus in ambient air. The result is the simple, stepwise reduction of oxygen molecules to DHP Gas on the electrocatalyst, which is subsequently released into the airflow passing through the catalyst.

2e⁻+2H⁺+O₂→H₂O₂

It should be noted that other species can be reduced under applied anodic potential. For example, recirculating DHP will be reduced to humidity preferentially. Other reductions are also possible.

To prevent the temporary shut-down of the electrocatalyst due to the buildup of protons, an alternating, or alternated current can be applied, alternating the potential regularly from applied cathodic to applied anodic while cathodic operation is still operating most efficiently and a supply, but not a gross surplus of protons is available on the electrocatalyst. The system can then be alternated back from applied anodic to applied cathodic operation before the supply of electrons is fully depleted, again performing the shift before a loss of efficiency occurs. By shifting the polarity of the potential, controlling the time during cathodic and anodic phases, and controlling the frequency, the production of DHP can be optimized.

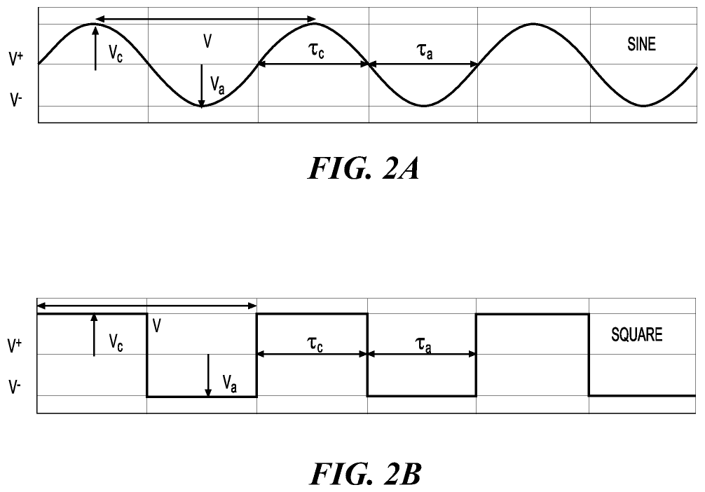

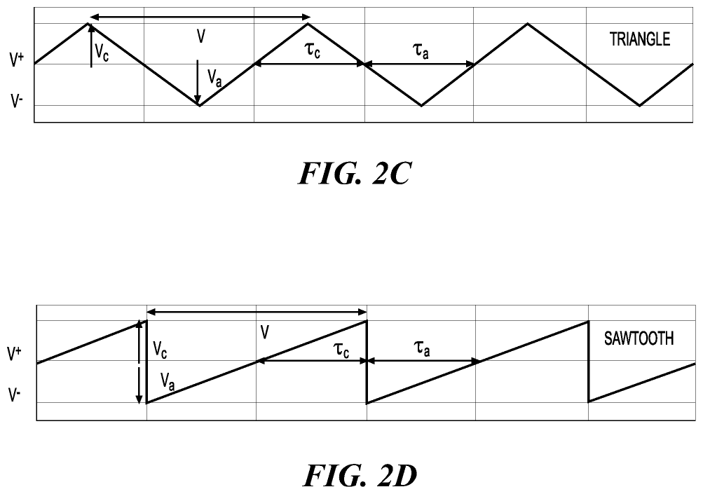

A number of different waveforms can be used. See FIG. 2. These include square wave, sinusoidal wave, triangular wave, sawtooth wave and combinations thereof. As used herein, each of these waves begins with a positive potential (cathodic) and transitions to a negative (anodic) potential.

The most efficient of these is the square wave, which transitions directly from peak cathodic potential immediately to peak anodic potential and back on a cycle. There is no lost efficiency due to the potential cycling down from a max positive to zero, then to a max negative potential and back. At potentials near zero there is insufficient energy to drive either the cathodic or anodic reactions and efficiency is expected to be lost.

Sinusoidal waves begin at maximum positive potential, then slope down to zero, then past zero until they reach a maximum negative potential, then they climb back to a maximum positive potential and repeat the cycle. This waveform uses a variable rate of potential increase/decrease and is expected to lose efficiency at potentials near zero.

Triangular waves, begin at max positive potential and use a constant rate of potential decrease to take the potential down to max negative potential, then use a constant rate of potential increase to max positive potential and then repeat the cycle. This waveform is also expected to lose efficiency at potentials near zero.

Sawtooth waves begin at max positive potential, then suddenly switch to max negative potential in the same manner as a square wave drops. The potential then increases at a constant rate back up to the max positive potential. This waveform also loses efficiency at potentials near zero as the potential nears zero while increasing, but does not lose efficiency as the potential drops from max positive to max negative.

While results demonstrate that ECM sails are more efficient than photocatalytic sails, not to be limited by theory, there appear to be limitations to DHP production. DHP concentrations maybe self-regulating due to the electrostatic attraction between DHP molecules which degrade to water and oxygen upon reacting with each other. DHP self-regulation occurs whenever the concentration of DHP results in intermolecular spacing that is closer in distance than the electrostatic attraction range of the DHP molecules. When this occurs, DHP molecules are attracted to, and degrade each other until the concentration drops sufficiently that the intermolecular spacing is greater than the electrostatic attraction range of the DHP molecules.

The present disclosure provides for devices that provide for the production of DHP using the electrolytic process comprising an electrically conductive network coated with a catalyst and powered by an electrical power source having a variable waveform generator. The device can be installed into a separate enclosure comprising an air distribution mechanism or installed into an HVAC system that provides for an air distribution mechanism. In aspects, the devices may further comprise a UV light source that allows for a dual mode photocatalytic/electrocatalytic production of DHP.

As used herein, an “electrically conductive network” refers to a meshwork, a microgrid, a fabric, an extruded catalyst, or structure that is electrically conductive. As used herein, an air-permeable electrically conductive network refers to a meshwork, gridwork, or a fabric. Also included, and provided for, are hollow-core electrically conductive networks. As used herein, unless indicated otherwise explicitly or clearly indicated by the context, the terms “electrically conductive network”, “air-permeable electrically conductive network”, “conductive network”, and “network” may be used interchangeably. The electrically conductive networks of the present disclosure, when coated by a catalyst, are also referred to as a “sail.” Previous photocatalytic devices included similar air permeable substrate structure (e.g., meshes) coated with a catalyst (e.g., “sails”) except that the substrate is non-conductive. Thus, it would be evident that certain TiO₂ catalyst coated conductive sails of the present disclosure could be incorporated in prior art devices (e.g., as described in International Patent Publication No. WO 2015/171633 and the '617 Publication). However, the earlier sails are not compatible with the present disclosure which requires a conductive substrate structure.

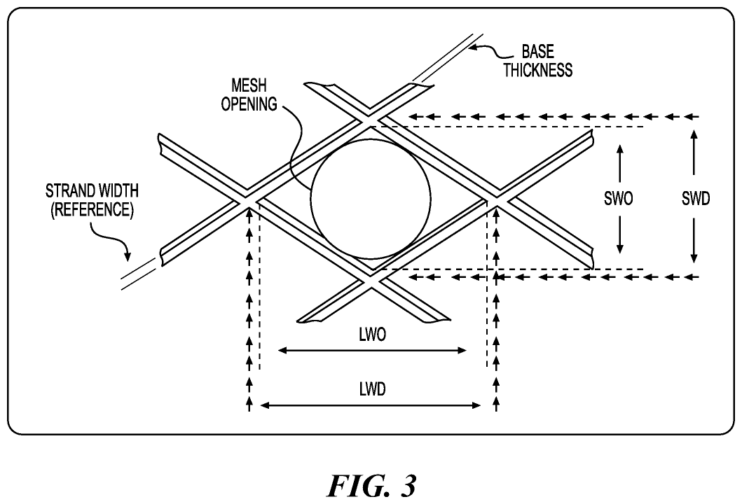

The electrically conductive networks can be prepared having a variety of dimensions. FIG. 3 presents a diagram of a meshwork identifying the dimensions that can be changed of a diamond-shaped unit cell. Each cell of the mesh comprises a long way of the diamond (LWD) which is the length of the long axis of the diamond measured from the center of the adjacent joint. The short way of the diamond (SWD) is the length of the short axis of the diamond measured from the center of the joint to the center of the joint. The strand width is the width of strands when observed from the top or bottom. The long way of the opening (LWO) is the length of the long axis of the opening of the diamond measured from the interior of the two adjacent joints. The short way of the opening (SWO), is the length of the short axis of the opening of the diamond measured from the interior of the two adjacent joints. It will be understood that when the LWD and SWD are equal, the grid or mesh adopts the shape of a square. The opening is described by the diameter of the circle that can fit inside. Suitable dimensions are provided in Table 1 but should not be considered as limiting. In aspects of the present specification, the dimensions may vary.

TABLE 1
Network dimensions suitable for electrically conductive networks.

| | SWD | | Hole Size | | Openings/ | | Open Area | | Raw Thickness | |
|---|---|---|---|---|---|---|---|---|---|---|
| LWD | (mm) | | (mm) | | mm² | | (%) | | (mm) | |
| (mm) | Min | Max | Min | Max | Min | Max | Min | Max | Min | Max |
| 0.635 | 0.318 | 0.391 | 0.030 | 0.203 | 8.06 | 9.92 | 32 | 75 | 0.0254 | 0.0762 |
| 0.787 | 0.462 | 0.620 | 0.038 | 0.254 | 4.11 | 5.50 | 32 | 82 | 0.0254 | 0.127 |
| 1.016 | 0.564 | 0.820 | 0.051 | 0.432 | 2.71 | 3.49 | 24 | 85 | 0.0381 | 0.1524 |
| 1.270 | 0.620 | 0.907 | 0.076 | 0.559 | 1.74 | 2.54 | 21 | 89 | 0.0381 | 0.2032 |
| 1.524 | 0.770 | 1.105 | 0.076 | 0.686 | 1.21 | 1.78 | 20 | 90 | 0.0381 | 0.2286 |
| 1.905 | 0.770 | 0.940 | 0.084 | 0.762 | 1.12 | 1.36 | 15 | 90 | 0.0381 | 0.2286 |
| 1.956 | 0.846 | 1.412 | 0.102 | 0.838 | 0.74 | 1.20 | 15 | 90 | 0.0508 | 0.3048 |
| 2.032 | 0.940 | 1.694 | 0.178 | 1.016 | 0.58 | 1.05 | 16 | 90 | 0.0508 | 0.3556 |
| 2.286 | 1.156 | 1.412 | 0.178 | 1.143 | 0.62 | 0.78 | 16 | 90 | 0.0508 | 0.3556 |
| 2.540 | 1.016 | 1.953 | 0.178 | 1.168 | 0.39 | 0.74 | 16 | 90 | 0.0508 | 0.4318 |
| 2.667 | 1.270 | 1.953 | 0.178 | 1.219 | 0.39 | 0.54 | 20 | 90 | 0.0508 | 0.4572 |
| 3.175 | 1.270 | 2.822 | 0.203 | 1.321 | 0.23 | 0.50 | 20 | 90 | 0.0508 | 0.635 |
| 3.556 | 1.494 | 3.175 | 0.254 | 1.651 | 0.17 | 0.39 | 30 | 90 | 0.0762 | 0.762 |
| 4.013 | 1.953 | 3.175 | 0.279 | 1.905 | 0.16 | 0.28 | 30 | 90 | 0.0762 | 0.762 |
| 4.572 | 1.814 | 2.822 | 0.279 | 2.032 | 0.16 | 0.23 | 32 | 90 | 0.1016 | 0.762 |
| 4.826 | 1.694 | 2.540 | 0.508 | 2.235 | 0.12 | 0.20 | 35 | 90 | 0.127 | 0.762 |
| 5.461 | 2.116 | 3.630 | 0.508 | 2.413 | 0.10 | 0.17 | 35 | 90 | 0.127 | 0.762 |

Other mesh shapes are suitable for the preparation of the electrically conductive networks of the present disclosures, including woven meshes. Woven meshes comprise warp threads that run lengthwise in a woven mesh or fabric, and weft or filling threads that run across the width of a fabric at right angles to the warp thread. In woven meshes comprising monofilaments, equal diameter threads and equal thread counts are present in both the warp and weft directions and square mesh openings (or holes). Monofilament woven meshes may have different numbers of thread counts in the warp and weft direction resulting in rectangular mesh openings. Woven meshes are available in a wide variety of thread counts.

Woven monofilament meshes suitable for devices of the present disclosure comprise meshes equivalent in size to the values provided in Table 1. In aspects, the nominal hole sizes (e.g., mesh openings) range from 0.03 mm to 2.5 mm. In an aspect, the number of openings per square millimeter (openings/mm), after coating with catalyst can be between 0.1 openings/mm to 10 openings/mm.

The impact of electrocatalytic DHP production is immense. With the production of DHP freed from the photocatalytic requirement of a light source and the maintenance of that light source, the design is no longer restricted by the size of the light source or the need to periodically replace it. Efficiency losses from the air-conditioned cooling of fluorescent bulbs, or the warming of light-emitting diodes by heating systems, are also eliminated. Further, because of the greatly increased efficiency of electrocatalysts, devices can be made even smaller, using respectively smaller and quieter fans. Energy requirements will also decrease markedly.

With regard to applications, a much broader field of venues and operational approaches are also possible. Electrocatalytic DHP devices can be deployed in smaller places, arrayed more efficiently for larger spaces, distributed more easily to provide multiple small point sources throughout a space, can operate at lower ambient temperatures, can operate at higher ambient temperatures, and can operate in more arid environments, as low as 1% relative humidity due to more efficient water adsorption compared to the current operational lower limit of 20% relative humidity.

The present specification provides for and includes, electrocatalytic devices employing an Alternating Current (AC) electrical power source. An electrocatalytic device having an AC power source is expected to be more efficient than direct current, but rapid, sudden, analog shifts from cathodic to an anodic state under standard utility cycles such as 60 cycles per second, or 60 Hertz, are not expected to establish a semi-steady state long enough to optimize DHP production using the sails of the present specification.

In other aspects, the production of DHP can be increased by layering the electrocatalytic mesh (ECM) sails. Photocatalytic sails require illumination, most efficiently direct illumination, and in theory are limited to the total cross-sectional surface area that is illuminated. While DHP producing photocatalytic sails comprise a mesh and thereby allowing some fraction of light to pass through, the amount is too limited to efficiently illuminate a second sail. Further, even if the mesh of a first stacked photocatalytic sail were configured to provide for significant pass through, optimizing efficiency would require aligning the subsequent sails out of the shadow of all of the preceding sails. The electrocatalytic system of the present disclosure is not similarly limited and provides a significant advantage to photocatalytic systems.

Not to be limited by theory, any number of ECMs can be incorporated in a device depending on the airflow, the amount of open area in the mesh, and ultimately the amount of available water in the air. Under high humidity conditions, a DHP generator of sufficient efficiency could convert all of the water to DHP; in practice much lower levels are obtained.

First, DHP concentrations maybe self-regulating due to the electrostatic attraction between DHP molecules, which degrade to water and oxygen upon reacting with each other. DHP self-regulation occurs whenever the concentration of DHP results in intermolecular spacing that is closer in distance than the electrostatic attraction range of the DHP molecules. When this occurs, DHP molecules are attracted to and degrade each other until the concentration drops sufficiently that the intermolecular spacing is greater than the electrostatic attraction range of the DHP molecules.

Second, the ECM sails will have reactive plasmas on their surfaces and the majority of the chemical species in the electrocatalytic plasma are reactive with hydrogen peroxide, and inhibit the production of hydrogen peroxide gas by means of reactions that destroy hydrogen peroxide. Thus, to optimize the production of DHP from devices having multiple ECM sails, the sails can be configured to minimize downstream interactions of DHP with the plasmas while it clears the ECM sail system. Accordingly, there is a practical limit on the number of ECM layers necessary for the optimal production of DHP (e.g., DHP that clears the ECM system). Given the variables, it is expected that the optimal number of ECMs would be determined empirically with high humidity, increased open area, increased airflow and pressure.

Provided for, and included in the present disclosure are devices with two or more ECM sails configured to reduce DHP destruction. In an aspect, the ECM sails are placed so that the meshes are not aligned. For example, each ECM can be rotated relative to each other. As provided herein, the relative rotation of an adjacent ECM can be between 0 and 90 degrees. In an aspect, the adjacent ECM sails are rotated 15° to 85° relative to each other. In an aspect, each layer can be rotated by 15°. In an aspect, each layer can be rotated by 30°. In another aspect, each layer can be rotated by 45 degrees. In another aspect, each layer can be rotated by 60 degrees. In yet another aspect, the relative rotation between two layers can be 75°.

Included and provided by the present specification are devices having between 2 and 10 ECMs, each configured to be rotated relative to each other. In an aspect, the devices have three ECM sails rotated by 15 degrees.

The present disclosure provides for, and includes, conductive networks that comprise a metal meshwork (“metal mesh”). In an aspect, the metal mesh comprises a metal selected from the group consisting of copper, annealed copper, silver, gold, aluminum, tungsten, zinc, nickel, iron, platinum, tin, titanium, grain oriented electrical steel, stainless steel, and nichrome. Any conductive metal having a conductivity (σ) between 6.3×10⁷ Siemens per meter (S/m) and 1×10⁵ S/m at 20° C. are suitable for preparing a meshwork and coating with the catalysts of the present disclosure to prepare a sail for the electrolytic production of DHP. Similarly, any suitable metal having a resistivity (p) between 1.5×10⁻⁸ ohm-meter (Ω·m) and 3×10⁻³ ohm-meter (Ω·m) at 20° C. are suitable for preparing a meshwork and coating with the catalysts of the present disclosure to prepare a sail for the electrolytic production of DHP. As provided herein, the metal meshes have a percentage of open area of between 20% and 60% after coating with a catalyst (see below for additional details).

The present disclosure further provides for, and includes, conductive networks that are organic conductive materials. To become effective, organic conductive materials (which are intrinsically non-active) are oxidatively doped—making them ideal materials for the generation of DHP. The materials are exposed to oxidative conditions to improve their conductivity from <10⁻⁸ S/cm to >0.1 S/cm. Suitable organic conductive materials include polyacetylene, PPV (polyphenylene vinylene), polypyrrole, polythiophene, or polyphenylene sulfide. In an aspect, the organic conductive material is polyacetylene. In an aspect, the organic conductive material is a polythiophene such as PEDOT:PSS mixture (poly(3,4-ethylenedioxythiophene-poly(styrenesulfonate)) as provided by Millipore-Sigma (St. Louis, Mo.).

The devices of the present disclosure include an electrically conductive network having a catalyst on the surface configured to produce dry hydrogen peroxide gas when applied to a current carrying electrically conductive network and provided an airflow. Not to be limited by theory, it is thought that hydrogen peroxide gas generated on the catalyst surface is released from the surface and thereby prevented from being reduced back into water by the catalyst or hydroxide.

The present disclosure also provides for electrically conductive networks that are coated with a catalyst to provide an electrocatalytic mesh (ECM). In some aspects, a network may comprise a material that is coated with one or more catalysts. In other aspects, a network may comprise a material that is coated with a catalyst and one or more co-catalysts. In yet another aspect, a network may comprise a material that is coated with a mixture of a catalyst, co-catalyst, and an additive.

A variety of methods for coating an electrically conductive network are currently known. In certain aspects, an electrically conductive network is coated with a crystalline titanium dioxide powder in one or more applications and sintered in an oven. The coatings of the present disclosure may be applied to a conductive network by a variety of methods including, but not limited to, gel sol methods, painting, dipping, and powder coating. In other aspects, the catalysts, co-catalysts and additives of the present disclosure may be applied to a conductive network by toll coating, tape casting, ultrasonic spray, and web-based coating. As provided herein, the method of applying the catalysts, co-catalysts, and additives is suitable if it provides for, and includes, retaining the conductive network of the underlying electrically conductive network as recited above.

### Preparation of Sails

Copper has excellent properties for use as an the electrically conductive network for the preparation of electrocatalytic meshes. However, copper (II) oxide is a semiconducting material with a resistance value 2-3 orders of magnitude larger than that of pure copper and thus only acts as an insulating layer hindering the free flow of electrons into the titanium dioxide. Therefore, it is important is to remove this layer. Copper (II) oxide is removed from the mesh material, following heat treatment, by submersion in concentrated acetic acid (<4% water by volume) at 35° C. for 15 minutes Chavez, K., & Hess, D. (2001). Novel Method of Etching Copper Oxide Using Acetic Acid. Journal of The Electrochemical Society, 148(11), G640-G643. doi:10.1149/1.1409400). The mesh is then dried under a nitrogen gas stream for 30 minutes in an oxygen-free environment.

Application of titanium dioxide to the composite surface may take one of several routes: UV activation (6 W, 312 nm) of titanium isopropoxide, electrodeposition of titanium bis(ammonium lactato)dihydroxide (Jeong et al., “Titanium dioxide-coated copper electrodes for hydrogen production by water splitting,” International Journal of Hydrogen Energy doi:10.1016/j.ijhydene. (2019)), anodic electrodeposition of titanium dioxide (Chigane et al., “Preparation of titanium dioxide thin films by indirect-electrodeposition,” Thin Solid Films 628:203-207 (2017)), co-electrodeposition of titanium dioxide with copper/nickel sulfate solution (Saifullin et al., “Copper Electroplating from Vanadate and Molybdate-Containing Electrolytes with Suspended Titanium Dioxide,” Protection of Metals 38:471-474 (2002) and Tseluikin, V., “Composite Electrochemical Coatings: Preparation, structure, properties,” Protection of Metals and physical chemistry of surfaces 45:312-326 (2008)), electrodeposition of pure titanium and subsequent growth of titanium dioxide with hydrofluoric acid, or mechanical deposition of titania (suspension submersion, mechanical coating, etc.). Additionally, flash heating may be used where the surface is exposed to 750° C. for a short interval (<1 sec) may be used to establish a Rutile:TiO₂-II:Anatase structure (Mols et al., “Influence of phase composition on optical properties of TiO₂: Dependence of refractive index and band gap on formation of TiO₂-II phase in thin films,” Optical Materials 96:109335 (2019); and Zhao et al., “Three-phase junction for modulating electron-hole migration in anatase-rutile photocatalysts,” Chemical Science (6):3483-3494 (2015)).

The present disclosure also provides for the use of adhesive layers 130 to join catalyst materials 135 to conductive meshes 125. In aspects, adhesives 130 are also used to adhere conductive materials 125 to non-conductive support materials 140.

In aspects of the present disclosure, adhesive layers are selected to join metal oxides to conductive inorganic materials. A variety of suitable materials are known including silane coupling agents (SCAs). SCAs coordinate to the surface of the conductive layer via an amine or thiol group leaving the siloxy portion of the molecule sticking out of the surface. The metal oxides are then adhered to the siloxy portion. In an aspect, the SCA is selected from the group consisting of 3-mercaptopropane trimethoxysilane, 3-mercaptopropane triethoxysilane, 3-mercaptopropane silane-triol, 3-aminopropane trimethoxysilane, 3-aminopropane triethoxysilane, and 3-aminopropane silane-triol. In an aspect, the SCA is 3-mercaptopropane trimethoxysilane. In another aspect, the SCA is 3-mercaptopropane triethoxysilane. In a further aspect, the SCA is 3-mercaptopropane silane-triol. In yet another aspect, the SCA, 3-aminopropane trimethoxysilane. In an aspect, the SCA is 3-aminopropane triethoxysilane. In yet a further aspect, the SCA is 3-aminopropane silane-triol. In yet another aspect, the SCA is 3-mercaptopropanioc acid.

When using conductive metals such as Ag and/or Cu, the amino-terminated SCA gives stronger bonding interactions (Ag—NH₂R, Cu—NH₂R), whereas with Ni, stainless steel, the thiol-terminated SCA gives stronger bonding interactions (Ni-SR, stainless steel-SR). An example of this technique would be to react the Ag or Cu mesh network with 3-aminopropyl trimethoxysilane to provide a coated surface where the amine was directly attached to the surface of the metal—leaving the siloxane exposed for electrocatalyst deposition. The —Si(OR₃) (R═—H, —CH₃ or CH₂CH₃) then reacts with the TiO₂ (or other electrocatalyst) to form covalent bonds to the electrocatalyst—increasing the adhesion to the metallic surface. This is described in the Gelest (Morrisville, Pa.) publication, “Silane Coupling Agents: Connecting Across Boundaries”, 3^{rd} Ed., B. Arkles (which can be downloaded from the internet at www(dot)gelest(dot)com/wp-content/uploads/Goods-PDF-brochures-couplingagents.pdf).

Furthermore, for increased stability, either electroplating Ag or Cu conductive mesh networks with a Ni-based solution or Cr-based solution (see “Nickel Plating Handbook” 2014 from the Nickel Institute), or using an electroless deposition of Ni onto the surface of Ag or Cu conductive mesh networks (as supplied by Coating Technologies (Phoenix, Ariz.) or Metal Chem., Greer, S.C.)— a layer having better adhesion for the electrocatalyst is obtained. Additionally, any electromobility of Cu²⁺ or Ag⁺ ions (obtained through oxidation of the metal mesh network) is eliminated by incorporating these layers directly on the conductive trace surface. Furthermore, as an optional layer—the SCA layer using the 3-mercaptosiloxane (HS—CH₂CH₂CH₂Si(OR)₃, where R═—H, —CH₃, —CH₂CH₃) may also be used on the resulting electroplated or electroless plated layers to also increase adhesion after the electromobility issue has been solved with the Ni or Cr plating.

In aspects of the present disclosure, adhesive layers are selected to join metal oxides to conductive organic materials (J. Linden, “Surface modified silica nanoparticles as emulsifier,” M.S. Thesis in Materials and Nanotechnology, Chalmers University of Technology; and Giaume et al., “Organic Functionalization of Luminescent Oxide Nanoparticles toward Their Applications As Biological Probes,” Langmuir, 24:11018-11026 (2008). Types of suitable adhesive materials include vinyl triethoxysilane (or vinyl trimethoxysilane or vinyl silane-triol), C₆ through C₂₄ trimethoxysilane, C₆ to C₂₄ triethoxysilane, or C₆ to C₂₄ silane-triol. In an aspect, the adhesive for joining metal oxides to a conductive organic material is dodecyl trimethoxysilane, dodecyl triethoxysilane, or dodecyl silane-triol. Not to be limited by theory, these adhesives are thought to work by van der Waals interactions with the organic conductor material, or through polymerization with the conductor material to provide a terminal group consisting of either trimethoxysilane, triethoxysilane, or silane-triol, which will bind the electrocatalyst material strongly.

In aspects of the present disclosure, the adhesive layer is applied through a dip-coating process onto those substrates where the substrate is an inorganic conductive layer. The substrate material is simply dipped into a solution containing 1×10⁻³ M to 0.5 M concentration of the SCA in question. After dipping, the substrate is then heated to a temperature between 80° C. and 120° C. to ensure appropriate bonding of the SCA to the metal itself. In those aspects where the conductive material is organic in nature, dip-coating the organic conductive material into a solution containing 1×10⁻³ M to 0.5 M concentration of the SCA may be used with mild heating in an inert atmosphere (N₂ or Ar) at 50° C. to 80° C. In those aspects where polymerization of the conductive substrate occurs (such as with polyphenylene vinylene), 0.01-0.5 wt % of the SCA (compared to the monomer material used) may be incorporated (specifically the vinyl triethoxysilane, vinyl trimethoxysilane or vinyl trisilan-triol) into the polymerization matrix to incorporate it indirectly within the conductor material.

The devices of the present disclosure provide for, and include, a catalyst on the surface of said electrically conductive networks. In certain aspects, a catalyst may be a catalyst mixture comprising one or more catalysts. In other aspects, a catalyst mixture may comprise one or more catalysts and one or more co-catalysts. In another aspect, a catalyst mixture may comprise one or more catalysts and one or more additives. In a further aspect, a catalyst mixture may comprise one or more catalysts, one or more co-catalysts, and one or more additives. Catalyst mixtures may further comprise solubilizer, binders, viscosity modifiers, isotonizing agents, pH regulators, solvents, dyes, gelling agents, thickeners, buffers, and combinations thereof.

One of ordinary skill in the art would understand that the selection of the catalyst determines the type of electrocatalysis that occurs upon application of an electrical potential. As discussed above, hydroxyl radicals produced by electrocatalysis must be removed from the catalytic surface before they undergo reduction by free electrons on the catalyst or by other reactive species produced by catalysis. This forces them to combine to form hydrogen peroxide just beyond the catalyst. One of ordinary skill in the art would understand that the residence time of dry hydrogen peroxide gas on the electrically conductive network is determined by the thickness of the substrate, the angle of incidence of the airflow, and the airflow velocity.

In aspects according to the present disclosure, the catalyst on the surface of an electrically conductive network is a metal, a metal oxide, or mixtures thereof. Also provided for and included in the present disclosure are ceramic catalysts. Catalysts of the present disclosure include, but are not limited to, titanium dioxide, copper, copper oxide, zinc, zinc oxide, iron, iron oxide, or mixtures thereof. Suitable catalysts are provided, for example at Table 2. In some aspects, the catalyst is titanium dioxide in the form of anatase or rutile. In certain aspects, the titanium dioxide is the anatase form. In some aspects, the catalyst is titanium dioxide in the form of rutile. In other aspects, the titanium dioxide catalyst is a mixture of anatase and rutile. Also provided for, are catalysts on the surface that comprise tungsten trioxide (WO₃). Not to be limited by theory, the use an electric potential allows for the oxidation of water to hydroxyl radicals using a wider variety of materials that is available using a photocatalytic approach.

TABLE 2
Catalysts having suitable Band-gap Energies

| | Band-gap energy | 1^{st} | 2^{nd} | 3^{rd} |
|---|---|---|---|---|
| | (electron volts | Ionization | Ionization | Ionization |
| Catalyst | (eV)) | Potential | Potential | Potential |
| Si | 1.1 | 8.1517 eV | 16.345 eV | 33.492 eV |
| WSe₂ | 1.2 | | | |
| CuO | 1.21-1.51 | | | |
| CdS | 2.4 | | | |
| WO₃ | 2.4-2.8 | | | |
| V₂O₅ | 2.7 | | | |
| SiC | 3.0 | | | |
| TiO₂ (rutile) | 3.02 | | | |
| Fe₂O₃ | 3.1 | | | |
| TiO₂ anatase | 3.2 | | | |
| ZnO | 3.2 | | | |
| SrTiO₃ | 3.2 | | | |
| SnO₂ | 3.5 | | | |
| ZnS | 3.6 | | | |
| BaTiO₃ | 3.2 | | | |
| CaTiO₃ | 2.32 | | | |
| SrTiO₃ | 3.75 | | | |

In certain aspects, the catalyst may be tungsten oxide or a mixture of tungsten oxide with another metal or metal oxide catalyst. In some aspects, the catalyst is selected from the group consisting of tungsten(III) oxide, tungsten(IV) oxide (WO₂), tungsten(VI) oxide (WO₃), and tungsten pentoxide. In an aspect, the tungsten oxide is tungsten dioxide (WO₂). In another aspect, the catalyst may be a tungsten trioxide (WO₃) catalyst combined with a cesium co-catalyst. (See “Development of a High-performance Photocatalyst that is Surface-treated with Cesium,” available on the internet at www(dot)aist(dot)go(dot)jp/aist_e/latest_research/2010/20100517/20100517.html).

Other catalysts suitable for use in the present devices include, but are not limited to metal oxides of the type M¹M²O₃ where M¹ is typically a divalent cation and M² is a tetravalent cation (also known as perovskites). Examples of suitable metal oxides are titanates of alkaline earth metals such as calcium (Ca), strontium (Sr), and barium (Ba) 1. In an aspect, the catalyst comprises barium titanate (BaTiO₃). In an aspect, the catalyst comprises strontium titanate (SrTiO₃). In an aspect, the catalyst comprises calcium titanate (CaTiO₃).

The present disclosure provides for, and includes, catalysts that are polyoxometallates. Polyoxometallates are polyatomic ions that consist of three or more transition metal oxyanions that are linked together to form 3-D frameworks. These are considered nanoparticles in which a large degree of functionality can be incorporated due to the fact that multiple transition metals are utilized. See Roy et al., Inorg. Chem. 55(7):3364-3377 (2016).

The catalysts of the present disclosure may further include one or more co-catalysts. In certain aspects, the present disclosure provides for and includes using catalysts that are also photocatalysts. Co-catalysts of the present disclosure include, but are not limited to, platinum, gold, silver, copper, nickel, cesium, or palladium. In some aspects, the co-catalyst is a noble metal selected from the group consisting of gold, platinum, silver, rhodium, ruthenium, palladium, osmium, and iridium. In an aspect, the co-catalyst is gold. In another aspect, the co-catalyst is silver. In yet another aspect, the co-catalyst is platinum. In another aspect, the co-catalyst is an extruded ceramic. In certain aspects, the co-catalyst is zinc dioxide (ZnO₂). In some aspects, the co-catalyst is an extruded titanium dioxide ceramic (see Shon et al., “Visible Light Responsive Titanium Dioxide (TiO₂)—a review” available at epress.lib.uts.edu.au).

Co-catalysts of the present disclosure may be provided in various amounts relative to the catalyst. In general, co-catalysts can be provided at levels of up to about 5%. In certain aspects, the amount of co-catalyst is 5% or less, though mixtures of co-catalysts having a combined amount of up to 10% may be used in certain aspects. In certain aspects, up to 1.0% of the total mass of the catalyst may be a co-catalyst of the types described above. In some aspects, the total amount of co-catalyst is up to 0.05%. In yet other aspects, the co-catalyst is provided at between 0.005 and 0.05%. In some aspects, the co-catalyst is provided at between 0.01 and 0.05%. In another aspect, the co-catalyst is provided at between 0.01% to 0.02%. In certain aspects, the co-catalyst is provided a less than 0.05% of the total mass of the catalyst.

Catalysts of the present disclosure, optionally including co-catalysts and additives may be prepared according to methods known in the art. Suitable co-catalysis and additives include silver nitrate, cerium oxide and zinc oxide. Additives are included to reduce, for example, bacterial growth and to prevent UV induced degradation of the catalyst and electrically conductive network. The catalysts, co-catalysts and additives of the present disclosure may be applied to a conductive network by a variety of methods including, but not limited to, gel sol methods, painting, dipping, and powder coating. In other aspects, the catalysts, co-catalysts and additives of the present disclosure may be applied to a conductive network by toll coating, tape casting, ultrasonic spray, and web-based coating. As provided herein, the method of applying the catalysts, co-catalysts and additives is suitable if it provides for, and includes, retaining the conductive network of the underlying electrically conductive network as recited above.

In an aspect, the catalyst mixture is applied to a conductive network using a sol-gel method comprising the use of an alcoholic metal salt as the catalytic material. In certain aspects, the metal salt is Ti(OR)₄. The sol-gel methods may further include co-catalysts such as WO₃, SnO₂, Fe₂O₃, or ZnO. The gel solution may be applied by dipping the conductive network into the gel solution or painting the solution onto the electrically conductive network. The thickness of the catalyst mixture applied to the substrate may be controlled by controlling the dipping speed or by providing one or more coats. After drying, the coated substrate may be baked and then sintered at high temperatures. In certain aspects, the catalytic mixture may further include noble metals or transition metals. In some aspects, the catalyst mixture may further include noble metals such as Au, Pd, Pt, or Ag, and some transition metals such as MoO₃, Nb₂O₅, V₂O₅, CeO₂, or Cr₂O₃.

The electrocatalytic devices of the present disclosure provide for, and include, an electrical power source having a variable waveform generator.

The present disclosure provides for, and includes, electrolytic systems having a power source that provides a wide range of voltages. Not to be limited by theory, as the potential required to produce DHP is on the order of a few electron volts (eV), the power necessary to drive the electrocatalytic reaction is expected to be extremely low. Electrocatalytic devices having a potential of about 0.01 V or a current of about 0.01 Amp are capable of producing DHP on a titanium dioxide coated copper mesh sail. While at low power compared to familiar electronic devices, it is anticipated that electrocatalytic devices can be powered by voltages orders of magnitude below 0.01 V or a current of 0.1 ampere. As provided herein, an electrical power source provides a voltage between ±0.3 volts (V) and ±30 KV. Practically, an upper limit of usable voltage for an electrolytic device using ambient air is determined by the power necessary to generate ozone electrolytically. As ozone is an undesirable toxic gas, with no known useful medical application in specific, adjunctive, or preventive therapy, it is to be avoided when producing DHP. The power of the devices of the present disclosure are limited only by considerations of safety to minimize and avoid electric shock. The power of the present devices is further limited by the necessity to avoid the production of ozone. Ozone can be produced, for example, using dielectric barrier discharge methods from air for example as described in U.S. Pat. No. 4,970,056, issued Nov. 13, 1990, to Wooten et al., U.S. Pat. No. 5,766,560, issued Jun. 16, 1998, to Cole. Ozone is also produced by arcing between electrodes. Accordingly, the devices of the present disclosure are designed to operate at lower voltages that avoids arcing.

In aspects according to the present disclosure, the electrical power source is a power source providing a time varied electrical potention between 0.3 volts (V) and 30 kilovolts (KV) and a frequency between 0.00025 Hertz (Hz) and 4.5 gigahertz (GHz), and having a current between 0.01 Ampere (A) and 100 A. Suitable power profiles according the present specification are provided in Table 3.

TABLE 3
Electrocatalytic Power Profiles

| Maximum | Maximum | | | |
|---|---|---|---|---|
| Anodic Voltage | Cathodic Voltage | | | |
| Vₐ (volts) | V_{c} (volts) | τₐ (sec) | τ_{c} (sec) | ν (Hz) |
| 0.3 ≤ V_{c} ≤ 10 | 0.3 ≤ Vₐ ≤ 10 | 0.2 ≤ t ≤ 2000 | 0.2 ≤ t ≤ 2000 | 0.00025 ≤ v ≤ 2.5 |
| 2 ≤ Vc ≤ 10 | 2 ≤ Va ≤ 10 | 0.2 ≤ t ≤ 2000 | 0.2 ≤ t ≤ 2000 | 0.00025 ≤ v ≤ 2.5 |
| 10 ≤ Vc ≤ 50 | 10 ≤ Va ≤ 50 | 0.2 ≤ t ≤ 2000 | 0.2 ≤ t ≤ 2000 | 0.00025 ≤ v ≤ 2.5 |
| 50 ≤ Vc ≤ 100 | 50 ≤ Va ≤ 10 | 0.2 ≤ t ≤ 2000 | 0.2 ≤ t ≤ 2000 | 0.00025 ≤ v ≤ 2.5 |
| 100 ≤ Vc ≤ 200 | 100 ≤ Va ≤ 200 | 0.2 ≤ t ≤ 2000 | 0.2 ≤ t ≤ 2000 | 0.00025 ≤ v ≤ 2.5 |
| 200 ≤ Vc ≤ 300 | 200 ≤ Va ≤ 300 | 0.2 ≤ t ≤ 2000 | 0.2 ≤ t ≤ 2000 | 0.00025 ≤ v ≤ 2.5 |
| 0.3 ≤ V_{c} ≤ 10 | 2 ≤ Va ≤ 10 | 0.2 ≤ t ≤ 2000 | 0.2 ≤ t ≤ 2000 | 0.00025 ≤ v ≤ 2.5 |
| 2 ≤ Vc ≤ 10 | 10 ≤ Va ≤ 50 | 0.2 ≤ t ≤ 2000 | 0.2 ≤ t ≤ 2000 | 0.00025 ≤ v ≤ 2.5 |
| 10 ≤ Vc ≤ 50 | 50 ≤ Va ≤ 10 | 0.2 ≤ t ≤ 2000 | 0.2 ≤ t ≤ 2000 | 0.00025 ≤ v ≤ 2.5 |
| 50 ≤ Vc ≤ 100 | 100 ≤ Va ≤ 200 | 0.2 ≤ t ≤ 2000 | 0.2 ≤ t ≤ 2000 | 0.00025 ≤ v ≤ 2.5 |
| 100 ≤ Vc ≤ 200 | 200 ≤ Va ≤ 300 | 0.2 ≤ t ≤ 2000 | 0.2 ≤ t ≤ 2000 | 0.00025 ≤ v ≤ 2.5 |
| 2 ≤ Vc ≤ 10 | 0.3 ≤ Va ≤ 10 | 0.2 ≤ t ≤ 2000 | 0.2 ≤ t ≤ 2000 | 0.00025 ≤ v ≤ 2.5 |
| 10 ≤ Vc ≤ 50 | 2 ≤ Va ≤ 10 | 0.2 ≤ t ≤ 2000 | 0.2 ≤ t ≤ 2000 | 0.00025 ≤ v ≤ 2.5 |
| 50 ≤ Vc ≤ 100 | 10 ≤ Va ≤ 50 | 0.2 ≤ t ≤ 2000 | 0.2 ≤ t ≤ 2000 | 0.00025 ≤ v ≤ 2.5 |
| 100 ≤ Vc ≤ 200 | 50 ≤ Va ≤ 10 | 0.2 ≤ t ≤ 2000 | 0.2 ≤ t ≤ 2000 | 0.00025 ≤ v ≤ 2.5 |
| 200 ≤ Vc ≤ 300 | 100 ≤ Va ≤ 200 | 0.2 ≤ t ≤ 2000 | 0.2 ≤ t ≤ 2000 | 0.00025 ≤ v ≤ 2.5 |

In aspects of the present disclosure, a device for the production of dry hydrogen peroxide (DHP) comprises an electrically conductive network coated with a catalyst, an electrical power source, and a variable waveform generator. In aspects of the present disclosure, a device for the production of dry hydrogen peroxide (DHP) comprises an electrically conductive network coated with a catalyst, an electrical power source, and a 555 timer integrated circuit, or an ICL8038 circuit, or similar waveform generators known in the art. In aspects, the variable waveform generator may be prepared as fixed waveform generator. It will be understood by persons of skill in the art that for a given configuration, a fixed circuit providing an optimized waveform is within the scope of a variable waveform generator.

As used herein the term “about” refers to ±10%.

The terms “comprises,” “comprising,” “includes,” “including,” “having,” and their conjugates mean “including but not limited to.”

The term “consisting of” means “including and limited to.”

The term “consisting essentially of” means that the composition, method, or structure may include additional ingredients, steps, and/or parts, but only if the additional ingredients, steps, and/or parts do not materially alter the basic and novel characteristics of the claimed composition, method, or structure.

As used herein, the singular form “a,” “an,” and “the” include plural references unless the context clearly dictates otherwise. For example, the term “a compound” or “at least one compound” may include a plurality of compounds, including mixtures thereof.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

As used herein the term “method” refers to manners, means, techniques, and procedures for accomplishing a given task including, but not limited to, those manners, means, techniques, and procedures either known to or readily developed from known manners, means, techniques, and procedures by practitioners of the agronomic, chemical, pharmacological, biological, biochemical, and medical arts. Methods may include single or multiple steps.

In aspects according to the present disclosure, an enclosure comprises a volume having at least one opening for the entry of air and at least one opening for the discharge of air having dry hydrogen peroxide gas. In some aspects, the enclosure may be prepared from metal, polytetrafluoroethylene, polyethylene, polypropylene, polystyrene, nylon, or polyvinyl chloride.

As used herein, in other aspects, an enclosure can comprise a heating, ventilating, and air conditioning (HVAC) system. In other aspects, a device for producing DHP is a device placed in an HVAC system during construction. Suitable HVAC systems and appropriate standards are known in the art, for example standards developed by the Sheet Metal & Air Conditioning Contractors' National Association (SMACNA). As provided herein, devices suitable for installation into an HVAC system include the elements recited for standalone devices but wherein the enclosure and air distribution system are provided by the HVAC system. Devices suitable for installation into an HVAC system may further comprise an additional air distribution system (e.g., separate from the air distribution system of the HVAC system as a whole). Devices suitable for installation into an HVAC system may further comprise one or more additional filters to prevent contamination with dust or chemicals.

In aspects according to the present disclosure, a device includes an air distribution mechanism to provide an airflow. In some aspects, the air flow is a continuous airflow. In other aspects, the air flow is discontinuous. In aspects according to the present disclosure, the airflow of the device may be a laminar flow of air though an ECM. In other aspects, the airflow may be turbulent flow through an ECM. In yet another aspect, the airflow may be transitional. In aspects according to the present disclosure, the airflow of the device may have a Reynolds number of less than 2300. In another aspect, the airflow of the device may have a Reynolds number of between 2300 and 4000. In yet another aspect, the airflow of the device may have a Reynolds number of greater than 4000.

In some aspects, an air distribution mechanism is placed upstream of an ECM and provides an airflow through the network. In other aspects, an air distribution mechanism is placed after an ECM and pulls the air through the network. In certain aspects, the airflow is provided by one or more fans. In yet another aspect, the air flow is provided by a climate control system such as an air conditioner, a furnace, or a heating, ventilation, and air-conditioning (HVAC) system.

Devices of the present disclosure are provided with an airflow sufficient to minimize the time of contact with the catalytic surface present on a conductive network.

The devices of the present disclosure include and provide for air distribution mechanisms capable of providing an airflow having a velocity from about 3000 cm/min to 15,000 cm/min as measured at the surface of the ECM. In certain aspects, suitable devices for HVAC systems are designed to handle air flows up to 40,000 cubic feet per minute (CFM).

In aspects, the direction of the airflow at the air permeable structure may be provided at an angle relative to the air permeable structure (the angle of incidence).

In aspects according to the present disclosure, the airflow through the ECM is humid air. In certain aspects, the humid air is ambient humid air. In other aspects, the humidity of the air flowing through the ECM is at or above 20% RH. In further aspects, the humidity of the air flowing through the ECM is at or above 30%. In some aspects, the relative humidity is between 35% and 40%. In other aspects, the humidity of the ambient air may be between about 20% and about 99% RH. In other aspects, the humidity of the ambient air may be between about 20% and about 99% RH. In certain aspects, the humidity of the air flow is less than 80%. In an aspect, the humidity is between 20% and 80%. In yet other aspects, the relative humidity is between 30% and 60%. In another aspect, the humidity is between 35% and 40%. In some aspects, the humidity of the air flowing through the ECM is between 56% and 59%. In aspects according to the present disclosure the relative humidity is between 20% and 80%.

The electrocatalytic devices of the present disclosure provide for, and include devices that operate under low humidity conditions. As used herein, a “low humidity condition” is a humidity of less than 20% RH. In other aspects, the humidity of the air flowing through the ECM is between 1% and 20% RH. In further aspects, the humidity of the air flowing through the ECM is at or above 10%. In some aspects, the relative humidity is between 5% and 20%. In other aspects, the humidity of the ambient air may be between about 5% and about 15% RH. In other aspects, the humidity of the ambient air may be between about 10% and about 20% RH.

In aspects according to the present disclosure, the airflow through the ECM may be supplemented by humidification. In certain aspects, ambient air is supplemented by a humidifier to provide an airflow having at least 20% humidity. In certain aspects, the relative humidity of the air flowing through permeable substrate structure is maintained at between 20% and 80%. In another aspect, the air may be humidified to 30% or higher relative humidity. In some aspects, the relative humidity of the humidified airflow is between 35% and 40%. In other aspects, the humidity of the humidified air may be between about 20% and about 99% or between about 30% to 99% RH. In an aspect, the relative humidity after humidification is less than 80%. In an aspect, the relative humidity after humidification is between 20% and 80%. In yet other aspects, the relative humidity after humidification is between 30% and 60%. In another aspect, the relative humidity after humidification is between 35% and 40%. In some aspects, the relative humidity after humidification of the air flowing through the ECM is between 56% and 59%.

In aspects according to the present disclosure, a device may provide an airflow that recirculates air within a space. In this mode, the device will self-regulate DHP levels by reducing excess DHP to humidity and oxygen as it recirculates through the device, instead of reducing oxygen to DHP. In other aspects, a device may provide, in whole or in part, an airflow comprising fresh air. In certain aspects, the device includes and provides for a source of fresh air either from the outside or from a separate filtered flow of air. In aspects according to the present disclosure, the device may be included in an air conditioning and ventilation system that recirculates air within a room or building. In some aspects, the recirculating room or building air may be supplemented with fresh outside air.

The present disclosure provides for electrically conductive networks having a catalyst on its surface that comprises a conductive layer 125 and a catalytic layer 135. As provided herein, the conductive layer 125 may be a solid conductive material or a hollow-core conductive material. High frequency AC currents have less resistance in hollow core conductive materials. In aspects, the conductive layer 125 is between 50×10⁻⁹ meters (nm) and 2×10⁻⁶ meters (μm). In aspects, the conductive layer 125 is between 100 nm and 2 μm. In aspects, the catalytic layer is between 50 nm and 150 μm thick.

In certain aspects according to the present disclosure, the electrically conductive network having a catalyst on its surface (e.g., the ECM) is between about 750 micrometers (μm) and about 1000 μm in total thickness. In an aspect, the thickness of the ECM is between 1000 and 2500 μm. In another aspect, the thickness of the ECM is between 2500 μm and 5000 μm. In an aspect, the thickness of the ECM is between 5000 μm and 7500 μm. In a further aspect, the thickness of the ECM is between 7500 μm and 10000 μm.

Also provided for and included in the present disclosure are devices having an electrically conductive network configured as a mesh. As used herein, a “mesh” refers to a network of spaces in a net or network comprising a network of cords, threads, or wires. The cords and threads can comprise a variety of known polymers (e.g., polypropylene (PP), polyethylene (PE), high-density polyethylene (HDPE), medium-density polyethylene (MDPE), low-density polyethylene (LDPE), polypropylene/polyethylene (PP/PE) blends, cross-linked polyethylene (PEX), ultra-high molecular weight polyethylene (UHMWPE) etc.) that have a conductive material impregnated within the fiber or are coated with a conductive material after formation of the strand. In certain aspects, the conductive material can be applied to the fabric after weaving or non-oriented cloth production. In some aspects, a mesh may be a woven cloth or fabric. Various weaves and meshes are known in the art to produce a mesh having round, triangular, square, polygonal, polyhedron, ellipsoid, or spherical openings suitable for providing for a flow of air. In some aspects, a mesh may be a woven wire. In certain aspects, a mesh may be a woven honeycomb shape. In other aspects, a mesh may be a nonwoven wire, metal impregnated polymer strand, metal-coated strand, or metal-coated fabric.

The present disclosure provides for and includes, electrically conductive networks having a mesh with an open area of between 20% and 60% and a maximal thickness of catalyst up to 750 um. Also included are electrically conductive networks having a mesh with an open area of about 40%. In an aspect the mesh opening is about 200 microns and the thread thickness is about 152 microns.

In aspects according to the present disclosure, a mesh is greater than 20 strands per centimeter. In certain aspects, the open area of the mesh is less than about 120 strands per centimeter. In an aspect, the mesh opening is about 200 microns (μm) corresponding to about 41% open area for a thread thickness of about 150 microns. In certain aspects, the mesh includes an open area of at least about 20% and a thread thickness of about 48 microns. In certain aspects, the mesh has a hole size of between 25 μm and 220 μm and having an open area of between 20% and 40%. In other aspects, the mesh has a hole size of between 25 μm and 220 μm and a thread thickness of between 48 μm and 175 μm.

In aspects according to the present disclosure, a mesh may be prepared having a regular, repeating pattern of spaces in the net or network. In other aspects, a mesh of the present disclosure may have an irregular or non-repeating pattern of spaces. In yet another aspect, the mesh may be a random array of open spaces. In another aspect, the mesh may have a honeycomb appearance. In aspects according to the present disclosure, the open spaces within the mesh are round, triangular, square, polygonal, polyhedron, ellipsoid, or spherical.

According to the present disclosure, an ECM comprises a mesh having a percentage of open area of between 20% and 60% after coating. In another aspect, the conductive network may have an open area of between 20% and 30%. In an aspect, the conductive network may have an open area of between 30% and 40%. In a further aspect, the conductive network may have an open area of between 40% and 50%. In yet another aspect, the conductive network may have an open area of between 50% and 60%. In certain aspects, the percentage of an open area of the conductive network may be between 36% and 38%. In an aspect, the percentage of open area is about 37%.

The present disclosure provides for, and includes, ECMs having a combined thickness of between 1 μm and 7 mm and having an open area of a mesh between 10% and 60%. In an aspect, the substrate structure may have a thickness selected from the group consisting of 5 μm to 15 μm, 15 μm to 30 μm, 20 μm to 40 μm, 30 μm to 50 μm, 50 μm to 75 μm, 75 μm to 100 μm, 100 μm to 250 μm, 250 μm to 500 μm, and 500 μm to 750 μm and having an open area of mesh between 10% and 20%. In an aspect, the substrate structure may have a thickness selected from the group consisting of 5 μm to 15 μm, 15 μm to 30 μm, 30 μm to 50 μm, 50 μm to 75 μm 75 μm to 100 μm, 100 μm to 250 μm, 250 μm to 500 μm, and 500 μm to 750 μm thick and has an open area of mesh between 20% and 30%. In an aspect, the substrate structure may have a thickness selected from the group consisting of 5 μm to 15 μm, 15 μm to 30 μm, 30 μm to 50 μm, 50 μm to 75 μm, 75 μm to 100 μm, 100 μm to 250 μm, 250 μm to 500 μm, and 500 μm to 750 μm thick and has an open area of mesh between 30% and 40%. In an aspect, the substrate structure may have a thickness selected from the group consisting of 5 μm to 15 μm, 15 μm to 30 μm, 30 μm to 50 μm, 50 μm to 75 μm, 75 μm to 100 μm, 100 μm to 250 μm, 250 μm to 500 μm, and 500 μm to 750 μm thick and has an open area of mesh between 40% and 50%. In an aspect, the substrate structure may have a thickness selected from the group consisting of 5 μm to 15 μm, 15 μm to 30 μm, 30 μm to 50 μm, 50 μm to 75 μm, 75 μm to 100 μm, 100 μm to 250 μm, 250 μm to 500 μm, and 500 μm to 750 μm thick and has an open area of mesh between 50% and 60%. In an aspect, the substrate structure may have a thickness selected from the group consisting of 5 μm to 15 μm, 15 μm to 30 μm, 30 μm to 50 μm, 50 μm to 75 μm, 75 μm to 100 μm, 100 μm to 250 μm, 250 μm to 500 μm, and 500 μm to 750 μm thick and has an open area of mesh between 36% and 38%.

Suitable electrically conductive networks for coating with a catalyst mixture according to the present disclosure include meshes, such as woven cloth or fabric or unwoven cloth or fabric. As provided herein, the coating of a suitable mesh with a catalyst mixture requires that the mesh not be occluded and that the mesh retain an open area of between 20% and 60% as provided above.

In certain aspects, devices of the present disclosure may be degraded by the presence of contaminants such as dust, pollen, bacteria, spores, and particles that can occlude the open spaces of a mesh of the ECM. Similarly, volatile organic compounds (VOCs) that can react with reactive species, including hydrogen peroxide, decrease the production of DHP and the distribution of DHP to a space. Notably, while VOCs can be effectively reduced in a space by DHP produced devices of the present disclosure, VOCs introduced into the device itself are preferably minimized or eliminated altogether. Accordingly, to maintain the efficiency of the devices and to maximize DHP production, devices of the present disclosure may include one or more filters. As will be noted, the selection of the filters may be determined by the application and the type of space to be treated using DHP. For example, a clean room in which air is already treated to eliminate dust, VOCs, and other contaminants could employ a device having an enclosure, an air distribution mechanism, an electrical power source, and an electrically conductive network having a catalyst on its surface without requiring a prefilter. In contrast, a device for home use might require a dust filter and might further require a carbon filter to absorb VOCs. In certain aspects, the inclusion of an additional filter provides for the extended life of the air-permeable catalyst coated substrates and provides for the extended production of DHP.

Filters used to purify air unrelated to DHP generation are dependent on the air quality of the location in which the device is used. Inside an HVAC system with high-quality air achieved by the filters of the HVAC system, no filters may be necessary before the air flow passes through the ECM of the DHP device itself. The same holds true for stand-alone devices operating in areas where there is high air quality. When necessary, filters are generally selected from those known in the art that can achieve the filtration required with as little impedance of air flow necessary. Filters are further selected from those known in the art so that the filter itself does not introduce particulates or gasses into the airstream. Suitable filters that combine the functions of removing particulates, as well as gaseous contaminants, are known in the art. Filters require replacement regularly, with a frequency determined by the load placed upon the filter due to higher air quality (less frequent replacement) or lower air quality (more frequent replacement).

In most applications three filtration concerns are applicable. In certain applications, particulates or dust can foul the substrate matrix and the catalyst itself, so a particulate filter sufficient to the needs of the location may be used. In certain common aspects, a high air-flow, pleated MERV 18 filter is employed. In other applications, volatile organic hydrocarbons may require filtration and this may be accomplished using a number of different activated charcoal or carbon impregnated filters that are known in the art. In yet other applications, certain inorganic gasses such as nitrogen oxides need to be removed by filtration. To remove nitrogen oxides, a zeolite filter is usually employed. In some aspects, the DHP device includes impregnated zeolite filters that are capable of removing volatile organic hydrocarbons and nitrogen oxides in a single, combined material and stage. Suitable filters are known in the art that can remove particles of various sizes that would otherwise block the ECM or contaminate and inactivate the catalytic surface.

In aspects of the present disclosure, devices may further include one or more filters designed to remove contaminants selected from nitrogen oxides (NOx), sulfur oxides (SOx), volatile organic compounds, dust, bacteria, pollen, spores, and particles. In certain aspects, the device includes one or more filters selected from an organic vapor filter, a particulate filter, a high-efficiency filter, a hydrophobic filter, an activated charcoal filter, or a combination thereof.

In certain aspects, pre-filters remove volatile organic compounds, NOx, and SOx. In some aspects, the filters remove aldehydes such as formaldehyde or acetaldehyde. In other aspects, the filters remove VOCs including toluene, propanol, and butene. In yet other aspects, pre-filters remove the mono-nitrogen oxides NO and NO₂ (e.g., NOx). In other aspects, pre-filters remove sulfur and oxygen-containing compounds known as SOx. SOx compounds removed by filters of the present disclosure include SO, SO₂, SO₃, S₇O₂, S₆O₂, S₂O₂, or combinations thereof. Prefilters of the present disclosure may be employed to remove any combination of VOCs, NOx, and SOx.

In certain aspects, the devices include a filter comprising a microporous aluminosilicate mineral. In an aspect, a filter of the present device may be a zeolite filter. In an aspect, the zeolite may be analcime, chabazite, clinoptilolite, heulandite, natrolite, phillipsite, or stilbite. In certain aspects, the zeolite may be a synthetic zeolite. In an aspect, the device includes a zeolite filter for the removal of NOx, SOx, or both. Suitable filters are known in the art.

In other aspects, the devices include a filter comprising a particulate filter. In certain aspects, the particulate filter is a 3M ultra allergan filter. A suitable example of a particle filter can be obtained from Air Filters, Inc, which provides Astro-cell mini-pleat filters. One of ordinary skill in the art would be able to select filters that provide suitable air flow levels and resistance to air flow to provide for a sufficient air flow through the ECM as recited above.

In yet other aspects, suitable filters for devices of the present disclosure include carbon filters, charcoal filters, or activated carbon filters. In some aspects, the filter is a GAC (granular activated carbon) carbon filter. In certain aspects, an impregnated carbon filter is included in a device to remove hydrogen sulfides (H₂S) and thiols. Suitable impregnated carbon filters are known in the art.

Air filtration in devices according to the present disclosure provide for air flows across the ECM layer having low levels of contaminants and electrocatalysis inhibitors.

The present disclosure provides for, and includes, methods of using the electrolytic DHP producing devices for the reduction of microbes, volatile organic compounds (VOCs), and insects as previously reported using photocatalytic devices. The present devices, given their low power requirements, further provide for methods that apply DHP technology to remote locations. In an aspect, electrolytic DHP producing devices can be made portable and wearable. In an aspect, the present disclosure provides for a method of providing a device comprising an electrically conductive network coated with a catalyst (ECM) and having an electrical power source that provides an electrical potential to said electrically conductive network, providing a flow of humid air through said electrically conductive network to prepare a DHP containing airflow, and directing said DHP containing airflow into an enclosed environment. After a period of time, DHP accumulates in the environment and acts to reduce microbial levels. In an aspect, the DHP is provided to an environment to reduce the levels of insects and arthropods, either by killing or repelling them. The period of time before the accumulation of DHP may vary with the environment, the number of devices, their size, air turnover and other factors. An important factor is the environment itself. Environments having high levels of VOCs require additional time to develop a steady level of DHP as the VOCs first need to be eliminated.

### EMBODIMENTS

Embodiment 1: A device for the production of dry hydrogen peroxide (DHP) comprising:
a. an electrocatalytic mesh (ECM) comprising an air permeable electrically conductive network coated with a catalyst;
b. an electrical power source having a variable waveform generator.

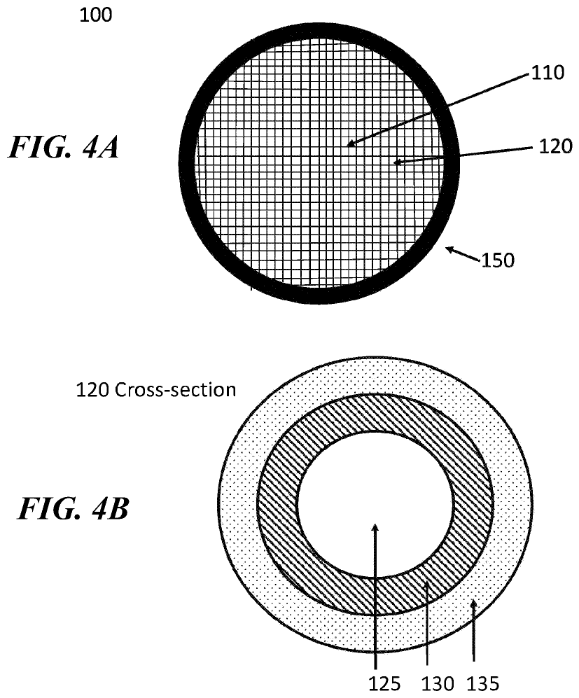

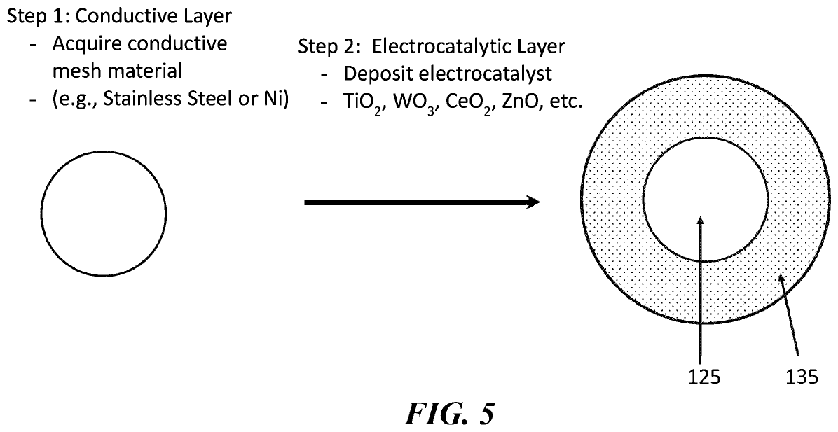

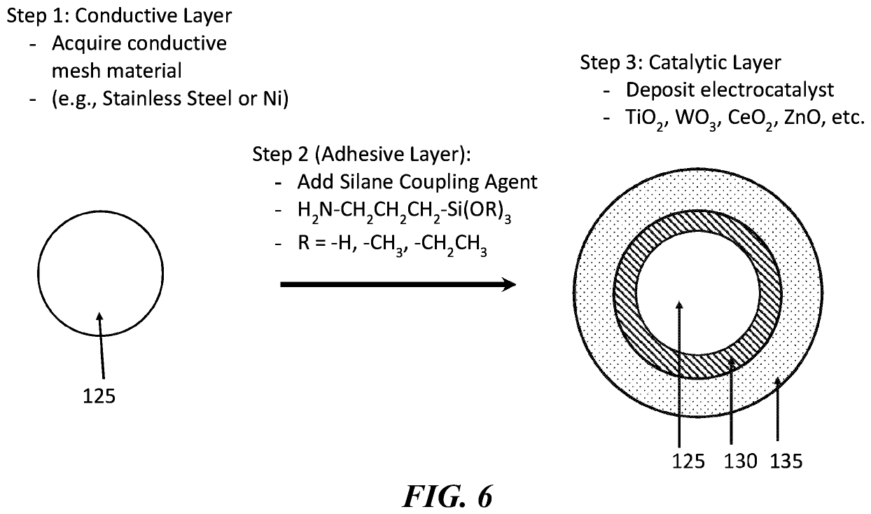

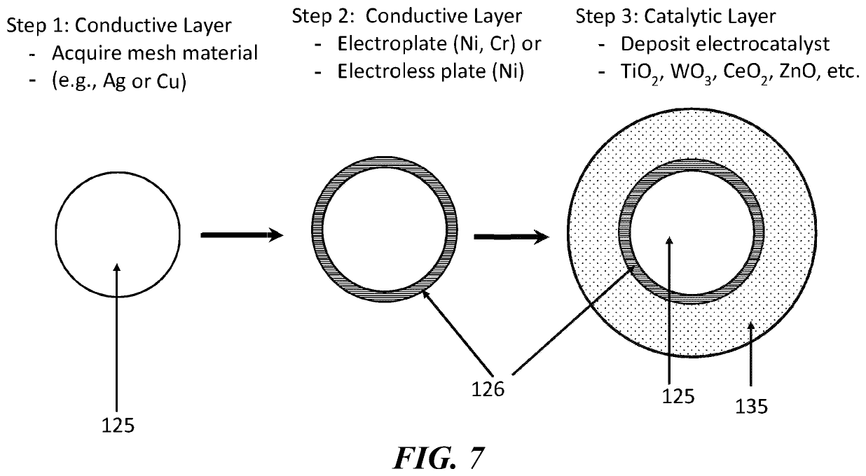

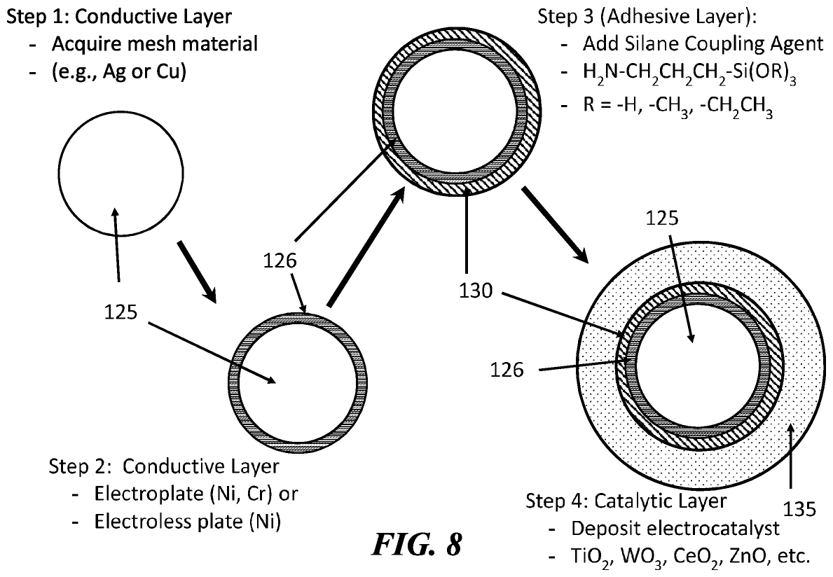

The present disclosure further includes, and provides for, devices having an electrically conductive network coated with a catalyst as illustrated in FIGS. 4 to 8 wherein the conductive layer 125, adhesive layer 130, catalyst layer 135, and non-conductive layer 140 comprise the materials as provided above. As will be understood by persons of skill in the art in view of the present disclosure, each of conductive layer 125, Adhesive layer 130, catalyst layer 135, and non-conductive layer 140 may further include additional components such as buffers and solvents as long as the materials do not change the overall property of an electrical conductivity and catalysis.

TABLE 4
Electrical Conductive Network Embodiments having
high performance, low cost, and availability

| Embodiment # | Configuration of certain electrical conductive networks |
|---|---|
| 4.1 | Conductive Layer: stainless steel |
| | Adhesive Layer: (3-mercaptopropyl)triethoxysilane |
| | Electrocatalytic Layer: TiO₂ (anatase) |
| 4.2 | Conductive Layer: aluminum |
| | Conductive Layer #2: electroless nickel layer |
| | Adhesive Layer: (3-mercaptopropyl)triethoxysilane |
| | Electrocatalytic Layer: TiO₂ (anatase) |
| 4.3 | Non-Conductive Layer: polyethylene terephthalate |
| | Conductive Layer: electroless nickel layer |
| | Adhesive Layer: (3-mercaptopropyl)triethoxysilane |
| | Electrocatalytic Layer: TiO₂ (anatase) |
| 4.4 | Conductive Layer: stainless steel |
| | Adhesive Layer: (3-mercaptopropyl)trimethoxysilane |
| | Electrocatalytic Layer: TiO₂ (anatase) |
| 4.5 | Conductive Layer: aluminum |
| | Conductive Layer #2: electroless nickel layer |
| | Adhesive Layer: (3-mercaptopropyl)trimethoxysilane |
| | Electrocatalytic Layer: TiO₂ (anatase) |
| 4.6 | Non-Conductive Layer: polyethylene terephthalate |
| | Conductive Layer: electroless nickel layer |
| | Adhesive Layer: (3-mercaptopropyl)trimethoxysilane |
| | Electrocatalytic Layer: TiO₂ (anatase) |
| 4.7 | Non-Conductive Layer: high density polypropylene |
| | Conductive Layer: electroless nickel layer |
| | Adhesive Layer: (3-mercaptopropyl)triethoxysilane |
| | Electrocatalytic Layer: TiO₂ (anatase) |
| 4.8 | Non-Conductive Layer: high density polypropylene |
| | Conductive Layer: electroless nickel layer |
| | Adhesive Layer: (3-mercaptopropyl)trimethoxysilane |
| | Electrocatalytic Layer: TiO₂ (anatase) |
| 4.9 | Non-Conductive Layer: high density polyethylene |
| | Conductive Layer: electroless nickel layer |
| | Adhesive Layer: (3-mercaptopropyl)triethoxysilane |
| | Electrocatalytic Layer: TiO₂ (antase) |
| 4.10 | Non-Conductive Layer: high density polyethylene |
| | Conductive Layer: electroless hickel layer |
| | Adhesive Layer: (3-mercaptopropyl)trimethoxysilane |
| | Electrocatalytic Layer: TiO₂ (anatase) |
| 4.11 | Conductive Layer: stainless steel |
| | Adhesive Layer: (3-mercaptopropyl)triethoxysilane |
| | Electrocatalytic Layer: TiO₂ (rutile) |
| 4.12 | Conductive Layer: aluminum |
| | Conductive Layer #2: electroless nickel layer |
| | Adhesive Layer: (3-mercaptopropyl)triethoxysilane |
| | Electrocatalytic Layer: TiO₂ (rutile) |
| 4.13 | Non-Conductive Layer: polyethylene terephthalate |
| | Conductive Layer: electroless nickel layer |
| | Adhesive Layer: (3-mercaptopropyl)triethoxysilane |
| | Electrocatalytic Layer: TiO₂ (rutile) |
| 4.14 | Conductive Layer: stainless steel |
| | Adhesive Layer: (3-mercaptopropyl)trimethoxysilane |
| | Electrocatalytic Layer: TiO₂ (rutile) |
| 4.15 | Conductive Layer: aluminum |
| | Conductive Layer #2: electroless nickel layer |
| | Adhesive Layer: (3-mercaptopropyl)trimethoxysilane |
| | Electrocatalytic Layer: TiO₂ (rutile) |
| 4.16 | Non-Conductive Layer: polyethylene terephthalate |
| | Conductive Layer: electroless nickel layer |
| | Adhesive Layer: (3-mercaptopropyl)trimethoxysilane |
| | Electrocatalytic Layer: TiO₂ (rutile) |
| 4.17 | Non-Conductive Layer: high density polypropylene |
| | Conductive Layer: electroless nickel layer |
| | Adhesive Layer: (3-mercaptopropyl)triethoxysilane |
| | Electrocatalytic Layer: TiO₂ (rutile) |
| 4.18 | Non-Conductive Layer: high density polypropylene |
| | Conductive Layer: electroless nickel layer |
| | Adhesive Layer: (3-mercaptopropyl)trimethoxysilane |
| | Electrocatalytic Layer: TiO₂ (rutile) |
| 4.19 | Non-Conductive Layer: high density polyethylene |
| | Conductive Layer: electroless nickel layer |
| | Adhesive Layer: (3-mercaptopropyl)triethoxysilane |
| | Electrocatalytic Layer: TiO₂ (antase) |
| 4.20 | Non-Conductive Layer: high density polyethylene |
| | Conductive Layer: electroless hickel layer |
| | Adhesive Layer: (3-mercaptopropyl)trimethoxysilane |
| | Electrocatalytic Layer: TiO₂ (rutile) |

TABLE 5
Electrical Conductive Network Embodiments
having high performance and availability

| Embodiment # | Configuration of certain electrical conductive networks |
|---|---|
| 5.1 | Conductive Layer: copper |
| | Conductive Layer #2: electroless nickel layer |
| | Adhesive Layer: (3-mercaptopropyl)triethyoxysilane |
| | Electrocatalytic Layer: TiO₂ (anatase) |
| 5.2 | Conductive Layer: copper |
| | Conductive Layer #2: electroless nickel layer |
| | Adhesive Layer: (3-mercaptopropyl)trimethoxysilane |
| | Electrocatalytic Layer: TiO₂ (anatase) |
| 5.3 | Conductive Layer: silver |
| | Conductive Layer #2: electroless nickel layer |
| | Adhesive Layter: (3-mercaptopropyl)triethoxysilane |
| | Electrocatalytic Layer: TiO₂ (anatase) |
| 5.4 | Conductive Layer: silver |
| | Conductive Layer #2: electroless nickel layer |
| | Adhesive Layer: (3-mercaptopropyl)trimethoxysilane |
| | Electrocatalytic Layer: TiO₂ (anatase) |
| 5.5 | Conductive Layer: copper |
| | Conductive Layer #2: electroplated nickel layer |
| | Adhesive Layer: (3-mercaptopropyl)triethoxysilane |
| | Electrocatalytic Layer: TiO₂ (anatase) |
| 5.6 | Conductive Layer: copper |
| | Conductive Layer #2: electroplated nickel layer |
| | Adhesive Layer: (3-mercaptopropyl)trimethoxysilane |
| | Electrocatalytic Layer: TiO₂ (anatase) |
| 5.7 | Conductive Layer: copper |
| | Adhesive Layer: (3-mercaptopropyl)triethoxysilane |
| | Electrocatalytic Layer: TiO₂ (anatase) |
| 5.8 | Conductive Layer: copper |
| | Electrocatalytic Layer: TiO₂ (anatase) |
| 5.9 | Conductive Layer: copper |
| | Conductive Layer #2: electroless nickel layer |
| | Adhesive Layer: (3-mercaptopropyl)triethyoxysilane |
| | Electrocatalytic Layer: TiO₂ (rutile) |
| 5.10 | Conductive Layer: copper |
| | Conductive Layer #2: electroless nickel layer |
| | Adhesive Layer: (3-mercaptopropyl)trimethoxysilane |
| | Electrocatalytic Layer: TiO₂ (rutile) |
| 5.11 | Conductive Layer: silver |
| | Conductive Layer #2: electroless nickel layer |
| | Adhesive Layter: (3-mercaptopropyl)triethoxysilane |
| | Electrocatalytic Layer: TiO₂ (rutile) |
| 5.12 | Conductive Layer: silver |
| | Conductive Layer #2: electroless nickel layer |
| | Adhesive Layer: (3-mercaptopropyl)trimethoxysilane |
| | Electrocatalytic Layer: TiO₂ (rutile) |
| 5.13 | Conductive Layer: copper |
| | Conductive Layer #2: electroplated nickel layer |
| | Adhesive Layer: (3-mercaptopropyl)triethoxysilane |
| | Electrocatalytic Layer: TiO₂ (rutile) |
| 5.14 | Conductive Layer: copper |
| | Conductive Layer #2: electroplated nickel layer |
| | Adhesive Layer: (3-mercaptopropyl)trimethoxysilane |
| | Electrocatalytic Layer: TiO₂ (rutile) |
| 5.15 | Conductive Layer: copper |
| | Adhesive Layer: (3-mercaptopropyl)triethoxysilane |
| | Electrocatalytic Layer: TiO₂ (rutile) |
| 5.16 | Conductive Layer: copper |
| | Electrocatalytic Layer: TiO₂ (rutile) |

TABLE 6
Further Electrical Conductive Network Embodiments

| Embodiment # | Configuration of certain electrical conductive networks |
|---|---|
| 6.1 | Non-Conductive Layer: cotton |
| | Conductive Layer: electroless nickel layer |
| | Adhesive Layer: (3-mercaptopropyl)triethoxysilane |
| | Electrocatalytic Layer: TiO₂ (anatase) |
| 6.2 | Non-Conductive Layer: cotton |
| | Conductive Layer: electroless nickel layer |
| | Adhesive Layer: (3-mercaptopropyl)trimethoxysilane |
| | Electrocatalytic Layer: TiO₂ (anatase) |
| 6.3 | Non-Conductive Layer: cotton |
| | Conductive Layer: electroless nickel layer |
| | Electrocatalytic Layer: TiO₂ (anatase) |
| 6.4 | Non-Conductive Layer: cotton |
| | Conductive Layer: electroless nickel layer |
| | Adhesive Layer: (3-mercaptopropyl)triethoxysilane |
| | Electrocatalytic Layer: TiO₂ (rutile) |
| 6.5 | Non-Conductive Layer: cotton |
| | Conductive Layer: electroless nickel layer |
| | Adhesive Layer: (3-mercaptopropyl)trimethoxysilane |
| | Electrocatalytic Layer: TiO₂ (rutile) |
| 6.6 | Non-Conductive Layer: cotton |
| | Conductive Layer: electroless nickel layer |
| | Electrocatalyst: TiO₂ (rutile) |
| 6.7 | Conductive Layer: stainless steel |
| | Electrocatalytic Layer: TiO₂ (anatase) |
| 6.8 | Conductive Layer: aluminum |
| | Conductive Layer #2: electroless nickel layer |
| | Electrocatalytic Layer: TiO₂ (anatase) |
| 6.9 | Non-Conductive Layer: polyethylene terephthalate |
| | Conductive Layer: electroless nickel layer |
| | Electrocatalytic Layer: TiO₂ (anatase) |
| 6.10 | Conductive Layer: stainless steel |
| | Electrocatalytic Layer: TiO₂ (anatase) |
| 6.11 | Conductive Layer: aluminum |
| | Conductive Layer #2: electroless nickel layer |
| | Electrocatalytic Layer: TiO₂ (anatase) |
| 6.12 | Non-Conductive Layer: polyethylene terephthalate |
| | Conductive Layer: electroless nickel layer |
| | Electrocatalytic Layer: TiO₂ (anatase) |
| 6.13 | Non-Conductive Layer: high density polypropylene |
| | Conductive Layer: electroless nickel layer |
| | Electrocatalytic Layer: TiO₂ (anatase) |

While the present disclosure has been described with reference to preferred embodiments, it will be understood by those skilled in the art that various changes may be made and equivalents may be substituted for elements thereof to adapt to particular situations without departing from the scope of the present disclosure. Therefore, it is intended that the present disclosure not be limited to the particular embodiments disclosed as the best mode contemplated for carrying out the present disclosure, but that the present disclosure will include all embodiments falling within the scope and spirit of the appended claims.

### EXAMPLES

### Example 1: Measurement of DHP

Hydrogen peroxide gas may be measured in a volume of air directly using a Picarro PI2114 Hydrogen Peroxide Concentration Analyzer in Air system (www(dot)picarro(dot)com).

### Example 2: Preparation of Electrocatalytic Meshes

TiO₂/Ni/Cu Mesh

an electrocatalytic mesh is constructed using the materials identified in Table 6. While other conductive materials can be treated and meshes prepared, copper is chosen for its relative abundance and electrical conductivity.

TABLE 7
Layered Copper Mesh

| Material | Copper |
|---|---|
| Mesh (cnt/in) | 30 |
| Wire Diameter (in) | 0.012 |
| Pore Size (in) | 0.0213 |
| Weft/Weave | Plain |
| % of Open Area | 40.96 |
| Weight (lb/ft\hat{ }2) | 0.336 |
| Purity (%) | 99.9 |

Sample pieces of 4″×4″ square are subjected to heat tempering. Copper softens as it is heated and subsequently quenched. Prior to the mating of future layers, the copper undergoes a pre-treatment sintering process.

Untreated copper develops a layer of copper (II) oxide on the surface of the mesh as a patina. Copper (II) oxide is a semiconducting material with a resistance value 2-3 orders of magnitude larger than that of pure copper and acts as an insulating layer hindering the free flow of electrons into the titanium dioxide and is removed by submersion in concentrated acetic acid (<4% water by volume) at 35° C. for 15 minutes. See Chavez and Hess “Novel Method of Etching Copper Oxide Using Acetic Acid,” Journal of The Electrochemical Society 148(11):G640-G643 (2002). The treated mesh is dried under a nitrogen gas stream for 30 minutes in an oxygen-free environment.

Following oxide removal and heat treatment, the copper mesh is coated by submersion in an electroless nickel plating solution. The nickel-plating solution is heated to 95-98° C., and the wire mesh remains in the solution to adequately coat the substrate. Acetic acid etching and nickel plating, may be repeated to ensure adequate coverage of the substrate.

The nickel coated copper mesh (“composite material”) is then sintered at 500° C. for a minimum of five minutes under oxygen free conditions to avoid the production of a nickel oxide coating. If necessary, cathodic cleaning of the composite mesh in hot concentrated acetic acid removes any nickel oxide layer that may have formed during the fabrication process (3-12V, 10-15 amps per square foot (asf), 35° C., 90 seconds).

Titanium dioxide is applied to the composite surface by UV activation (6 W, 312 nm) of titanium isopropoxide. Following titanium dioxide application, the mesh is sintered/calcinated at 500° C. for 60 minutes in an inert atmosphere if available. Exposure to temperatures above 500° C. is avoided to prevent phase changes of anatase to rutile. The thickness for the titanium dioxide coating does not exceed 10 μm to maximize diffusion effects of both electron-hole and intermediate chemical species.

Using the methods, test mesh materials are prepared using mechanical deposition (30 w/w % slurry TiO₂:H2O) and anodic electrodeposition of TiO₂ (5 w/w % slurry TiO2:H2O). All slurries are subject to ultrasonication and pH adjusted to a value of 2 by nitric acid addition, for optimal surface charge characteristics and size distributions (Holmberg et al., “Surface charge and interfacial potential of titanium dioxide nanoparticles: Experimental and theoretical investigations,” Journal of Colloid and Interface Science, 407:168-176 (2013)). Additional test materials are prepared using polyethylene glycol as an emulsification agent prior to ultra-sonification and removed via thermal degradation.

The resulting coated mesh composite material is the hardened using ultrasonic hardening. The resulting meshes are summarized in Table 8: Layered copper meshes for DHP production.

TiO₂/Ni/Zn-Coated Al Meshes

A TiO₂, nickel and zinc coated aluminum mesh is coated using an adaptation of the of the methods of Ho et al. “A super ink jet printed zinc-silver 3D microbattery,” J. Micromech and Microengr. 19:094013 (2019). Briefly, an aluminum mesh having a SWO of 1 mm (www.dexmet.com) is submersed into an aqueous electrolyte comprising a 0.7 M solution of ZnO in 8 M potassium hydroxide. Using a glassy carbon anode, the Al mesh is connected as the cathode and a 2 V bias is applied to plate Zn onto the surface of the Al mesh substrate. The Zn-coated Al-mesh substrate is removed from the plating solution and cleaned with deionized water after the deposition of a Zn layer that is at least 500 Angstrom (A) thick. The amount of time necessary to deposit the zinc film depends on upon the temperature of the bath, the time allowed for deposition to occur and the concentration of ZnO in solution. The coating of aluminum with zinc is known to persons of skill in the art.

The Zn-coated aluminum mesh is further coated with nickel using a nickel electroplating solution that consists of nickel sulfamate (Sigma-Aldrich). The Zn-coated Al mesh is connected as the cathode, and using a glassy carbon anode, a 2 V bias is applied to prepare a electrodeposit a nickel layer of at least 500 Å thick. The amount of time necessary to deposit the nickel layer depends on upon the temperature of the bath, the time allowed for deposition to occur and the concentration of Ni in solution. The electrodeposition of nickel is known to persons of skill in the art. The Ni-on-Zn-on-Al mesh (Ni/Zn-coated Al-mesh) substrate is removed from the plating solution and cleaned with deionized water.

The Ni/Zn-coated Al mesh is coated with titanium dioxide (TiO₂) using an aqueous solution of 50 mM solution of titanium trichloride (TiCl₃) and the pH adjusted to between 1 and 3 using concentrated hydrochloric acid (HCl, Sigma-Aldrich) in deionized H₂O. The Ni/Zn-coated Al mesh is placed in the plating solution as the cathode, and a 316 stainless steel electrode is used as the anode. Applying a 0.5 V bias, a 5 μm thick TiO₂ film is deposited. The amount of time depends on the temperature of the bath, the time allowed for deposition, and the concentration of TiCl₃ in solution. Once the desired thickness is obtained, the TiO₂/Ni/Zn-coated Al mesh is thoroughly rinsed with deionized water before annealing in air at 450° C. for 2 hours. The resulting mesh is an aluminum mesh having an electroplated coating of zinc between 100 to 500 nanometers thick, an electroplated nickel coating of between 100 nanometers to 1 micron thick, a monolayer of 3-mercaptopropane triethyoxysilane (3-MPS) and coated with P90 TiO2 nanoparticles (Evonik).

TiO₂/Al₂O₃Coated Aluminum Mesh

An aluminum mesh is coated with TiO₂ on an intermediate layer of Aluminum trioxide using an adaptation of the methods of Abdulagatov et al., “Al₂O₃ and TiO₂ Atomic Layer Deposition on Copper for Water Corrosion Resistance,” Appl. Mater. & Interfac. 3(12):4593-4601 (2011).

Briefly, an aluminum mesh having a SWO of 1 mm (Dexmet) is coated with Al₂O₃ by surface deposition on the surface by immersion in a solution of 97% pure TMA (tetramethylaluminum, Sigma-Aldrich) in 18 milliohm (me) H₂O at 177° C. After obtaining thickness of 100 to 500 nanometers thick, a TiO₂ atomic layer deposition (ALD) is done using a solution comprising 98% pure TiCl₄ (titanium tetrachloride, Strem Chemicals, Inc.) in 18 mΩ H₂O at 120° C.

TiO₂/SCA/Ni/Zn-Coated Al Mesh

A TiO₂ coated aluminum mesh is prepared using methods adapted from Enrodi et al., “One-Step Electrodeposition of Nanocrystalline TiO₂ Films with Enhanced Photoelectrochemical Performance and Charge Storage,” ACS Appl. Energy Mater. 1(2):851-858 (2018).

Briefly, an aluminum mesh having a SWO of 1 mm (Dexmet) is coated with Zn and nickel as described above and coated with TiO₂ as follows: The Ni-on-Zn-on-Al mesh (Ni/Zn-coated Al mesh) is treated with the coupling agent 3-mercaptopropyl triethoxylsilane (3-SCA) to increase the adhesion between the Ni-film and the deposited TiO₂ nanoparticles. The Ni/Zn-coated Al-mesh is washed in a 50 mM solution of SCA in 100% ethanol for 2 minutes then removed and heated on a hot plate for 2 minutes at 110° C. The resulting SCA on Ni/Zn-coated Al mesh is rinsed with deionized water to prepare an SCA/Ni/Zn-coated Al mesh. The SCA/Ni/Zn-coated Al mesh is soaked into a 15% (wt/wt) solution of P90 (Evonik) TiO₂ in deionized water for 2 minutes before removing and rinsing thoroughly with deionized water. The TiO₂ coating process is repeated two more times before the TiO₂/SCA/Ni/Zn-coated Al mesh is annealed for 1 hour at 450° C.

TABLE 8
Layered copper meshes for DHP production

| | | Intermediate | Adhesive | | |
|---|---|---|---|---|---|
| Mesh | Conductor | layer | Layer | Catalyst | Notes |
| A | Copper | Nickel | None | TiO₂ | Mechanical |
| | | (thickness) | | | deposition; |
| | | | | | rutile/anatase? |
| B | Copper | Nickel | None | TiO₂ | Electrodeposition |
| | | (thickness) | | | |
| C | Copper | Nickel | None | | Mechanical with |
| | | (thickness) | | | PEG |
| | | | | | emulsification |
| D | Aluminum | Zinc/Nickel | None | TiO₂ | |
| E | Aluminum | Zinc/Nickel | SCA | TiO₂ | |
| F | Aluminum | Aluminum | None | TiO₂ | |
| | | oxide | | | |

### Example 3: Preparation of Test Apparatus

Test Apparatus

A 4′×2′×2′ rectangular box (16 ft³) having a ¾ inch port for electrical supply and a ⅜″ port for an air sampling is prepared from 16 gauge 316 steel and lined with aluminum is prepared for a testing chamber. A 4″ diameter, 36″ inch ABS tube is prepared and designed to accommodate a 4″ diameter electrocatalytic sail cartridge. The sail cartridge is fitted with electrical leads to provide a potential difference across the substrate sail material. The end ABS tube is fitted with a centrifugal fan capable of providing airspeeds of 270 ft/min up to 1100 ft/min.

Temperature and relative humidity within the testing apparatus are measured using a HOBO UX100 temperature/RH logger (Company). Hydrogen peroxide levels are measured using two devices, an Interscan hydrogen peroxide sensor (Interscan, Inc. Model 4090-1999b) and a Picarro PI2114 hydrogen peroxide sensor. A PFTF manifold utilizing Clippard NIV PTFE Isolation valves (12 VDC, ⅜″ port) is used to provide a single sampling port from the test apparatus, and allow for switching between sampling and a zero reference created by activated charcoal filtering.

Power is supplied by direct DC generation from a generic DC power supply. 0.01V to 30V, 0.001 A to 5.1 A. The power supply is controlled by a controller (name, model) capable of generating direct currents having a voltage of between 0.01V and 30V and a power of 0.001 A and 5.1 amps. The power supply is also capable of generating switched polarity direct currents with varied potentials. The power supply is also capable of generating alternating currents. Examples of standard waveforms suitable for the methods and devices of the present specification are shown in FIG. 2.

Test Method

During testing, power is supplied to the ECM and fan and data from the Interscan and HOBO logger is collected every 60 seconds, utilizing an average of sample taken every second. Picarro logging occurred every 10 seconds and utilized a 5 minute averaging to report values.

The entire test apparatus is enclosed within a CZS Modular Walk-in Environmental Chamber controlled by an EZT570S. The test apparatus is a sealed system with the air removed for sampling replenished from the environmental chamber during testing.

During the stabilization period, DHP readings are obtained inside the test box. The glovebox portholes are sealed off while the DHP generating device fan is running without an installed sail. Once the Picarro readings stabilize (about 20 minutes), the applied potential to the electrocatalytic device is increased and Picarro readings obtained until the readings had stabilized.

To establish a baseline DHP level of the glovebox the Picarro is allowed to measure the device operating a bare Cu-mesh with no electrocatalyst on it while in the modified DHP generating device.

To begin testing the sail is inserted into the modified DHP generating device and energized by either connecting the electrodes to a standard 9V battery or to a Keithley DC power supply (m/n: 2260B-30-36 360 W) and the glovebox resealed. The test is run for a designated period of time and the data from the various sensors recorded on the data logger. At the end of the test period, the sample tube is disconnected from the Interscan and the C12 filter is reattached to the sensor inlet for about 20 minutes to determine whether the amount the zero point drifted. The HOBO logger is turned off to complete the test.

### Example 4: Application of Alternating Current Waveforms to Electrocatalytic DHP Production

The meshes prepared in the Examples above are placed into the apparatus and connected to electrodes. In tests, a cathodic voltage (V_{c}) is applied to the mesh for a period of time (τ_{c}) and an anodic voltage Va is applied to the mesh for a period of time (τₐ), where the frequency v, is defined as the sum of τ_{c}+τₐ. The device and apparatus are run for a time period using a square waveform as illustrated in FIG. 2 and the accumulation of DHP determined. The test parameters are presented in Table 9.

TABLE 9
A/C Test Parameters

| | Maximum | Maximum | | | |
|---|---|---|---|---|---|
| | Anodic | Cathodic | | | |
| Se- | Voltage Vₐ | Voltage V_{c} | τₐ | τ_{c} | ν |
| quence | (volts) | (volts) | (sec) | (sec) | (Hz) |
| 1 | 2 | 2 | 2000 | 2000 | 0.00025 |
| 2 | 2 | 2 | 2000 | 200 | 0.00045 |
| 3 | 2 | 2 | 200 | 2000 | 0.00045 |
| 4 | 2 | 2 | 200 | 200 | 0.0025 |
| 5 | 2 | 2 | 200 | 20 | 0.00455 |
| 6 | 2 | 2 | 20 | 200 | 0.00455 |
| 7 | 2 | 2 | 20 | 20 | 0.025 |
| 8 | 2 | 2 | 20 | 2 | 0.04545 |
| 9 | 2 | 2 | 2 | 20 | 0.04545 |
| 10 | 2 | 2 | 2 | 2 | 0.25 |
| 11 | 2 | 2 | 2 | 0.2 | 0.45455 |
| 12 | 2 | 2 | 0.2 | 2 | 0.45455 |
| | 2 ≤ Vc ≤ 10 | 2 ≤ Vc ≤ 10 | | | |
| 13 | 5 | 5 | 2000 | 2000 | 0.00025 |
| 14 | 5 | 5 | 2000 | 200 | 0.00045 |
| 15 | 5 | 5 | 200 | 2000 | 0.00045 |
| 16 | 5 | 5 | 200 | 200 | 0.0025 |
| 17 | 5 | 5 | 200 | 20 | 0.00455 |
| 18 | 5 | 5 | 20 | 200 | 0.00455 |
| 19 | 5 | 5 | 20 | 20 | 0.025 |
| 20 | 5 | 5 | 20 | 2 | 0.04545 |
| 21 | 5 | 5 | 2 | 20 | 0.04545 |
| 22 | 5 | 5 | 2 | 2 | 0.25 |
| 23 | 5 | 5 | 2 | 0.2 | 0.45455 |
| 24 | 5 | 5 | 0.2 | 2 | 0.45455 |
| | 2 ≤ Vc ≤ 10 | 2 ≤ Vc ≤ 10 | | | |
| 25 | 10 | 10 | 2000 | 2000 | 0.00025 |
| 26 | 10 | 10 | 2000 | 200 | 0.00045 |
| 27 | 10 | 10 | 200 | 2000 | 0.00045 |
| 28 | 10 | 10 | 200 | 200 | 0.0025 |
| 29 | 10 | 10 | 200 | 20 | 0.00455 |
| 30 | 10 | 10 | 20 | 200 | 0.00455 |
| 31 | 10 | 10 | 20 | 20 | 0.025 |
| 32 | 10 | 10 | 20 | 2 | 0.04545 |
| 33 | 10 | 10 | 2 | 20 | 0.04545 |
| 34 | 10 | 10 | 2 | 2 | 0.25 |
| 35 | 10 | 10 | 2 | 0.2 | 0.45455 |
| 36 | 10 | 10 | 0.2 | 2 | 0.45455 |
| | 2 ≤ Vc ≤ 10 | 2 ≤ Vc ≤ 10 | | | |
| 37 | 2 | 10 | 2000 | 2000 | 0.00025 |
| 38 | 2 | 10 | 2000 | 200 | 0.00045 |
| 39 | 2 | 10 | 200 | 2000 | 0.00045 |
| 40 | 2 | 10 | 200 | 200 | 0.0025 |
| 41 | 2 | 10 | 200 | 20 | 0.00455 |
| 42 | 2 | 10 | 20 | 200 | 0.00455 |
| 43 | 2 | 10 | 20 | 20 | 0.025 |
| 44 | 2 | 10 | 20 | 2 | 0.04545 |
| 45 | 2 | 10 | 2 | 20 | 0.04545 |
| 46 | 2 | 10 | 2 | 2 | 0.25 |
| 47 | 2 | 10 | 2 | 0.2 | 0.45455 |
| 48 | 2 | 10 | 0.2 | 2 | 0.45455 |
| | 2 ≤ Vc ≤ 10 | 2 ≤ Vc ≤ 10 | | | |
| 49 | 10 | 2 | 2000 | 2000 | 0.00025 |
| 50 | 10 | 2 | 2000 | 200 | 0.00045 |
| 51 | 10 | 2 | 200 | 2000 | 0.00045 |
| 52 | 10 | 2 | 200 | 200 | 0.0025 |
| 53 | 10 | 2 | 200 | 20 | 0.00455 |
| 54 | 10 | 2 | 20 | 200 | 0.00455 |
| 55 | 10 | 2 | 20 | 20 | 0.025 |
| 56 | 10 | 2 | 20 | 2 | 0.04545 |
| 57 | 10 | 2 | 2 | 20 | 0.04545 |
| 58 | 10 | 2 | 2 | 2 | 0.25 |
| 59 | 10 | 2 | 2 | 0.2 | 0.45455 |
| 60 | 10 | 2 | 0.2 | 2 | 0.45455 |
| | 10 ≤ Vc ≤ | 10 ≤ Vc ≤ | | | |
| | 50 | 50 | | | |
| 61 | 25 | 25 | 2000 | 2000 | 0.00025 |
| 62 | 25 | 25 | 2000 | 200 | 0.00045 |
| 63 | 25 | 25 | 200 | 2000 | 0.00045 |
| 64 | 25 | 25 | 200 | 200 | 0.0025 |
| 65 | 25 | 25 | 200 | 20 | 0.00455 |
| 66 | 25 | 25 | 20 | 200 | 0.00455 |
| 67 | 25 | 25 | 20 | 20 | 0.025 |
| 68 | 25 | 25 | 20 | 2 | 0.04545 |
| 69 | 25 | 25 | 2 | 20 | 0.04545 |
| 70 | 25 | 25 | 2 | 2 | 0.25 |
| 71 | 25 | 25 | 2 | 0.2 | 0.45455 |
| 72 | 25 | 25 | 0.2 | 2 | 0.45455 |
| | 50 ≤ Vc ≤ | 50 ≤ Vc ≤ | | | |
| | 100 | 10 | | | |
| 63 | 75 | 25 | 2000 | 2000 | 0.00025 |
| 64 | 75 | 25 | 2000 | 200 | 0.00045 |
| 65 | 75 | 25 | 200 | 2000 | 0.00045 |
| 66 | 75 | 25 | 200 | 200 | 0.0025 |
| 67 | 75 | 25 | 200 | 20 | 0.00455 |
| 68 | 75 | 25 | 20 | 200 | 0.00455 |
| 69 | 75 | 25 | 20 | 20 | 0.025 |
| 70 | 75 | 25 | 20 | 2 | 0.04545 |
| 71 | 75 | 25 | 2 | 20 | 0.04545 |
| 72 | 75 | 25 | 2 | 2 | 0.25 |
| 73 | 75 | 25 | 2 | 0.2 | 0.45455 |
| 74 | 75 | 25 | 0.2 | 2 | 0.45455 |
| | 100 ≤ Vc ≤ | 100 ≤ Vc ≤ | | | |
| | 200 | 200 | | | |
| 75 | 150 | 150 | 2000 | 2000 | 0.00025 |
| 76 | 150 | 150 | 2000 | 200 | 0.00045 |
| 77 | 150 | 150 | 200 | 2000 | 0.00045 |
| 78 | 150 | 150 | 200 | 200 | 0.0025 |
| 79 | 150 | 150 | 200 | 20 | 0.00455 |
| 80 | 150 | 150 | 20 | 200 | 0.00455 |
| 81 | 150 | 150 | 20 | 20 | 0.025 |
| 82 | 150 | 150 | 20 | 2 | 0.04545 |
| 83 | 150 | 150 | 2 | 20 | 0.04545 |
| 84 | 150 | 150 | 2 | 2 | 0.25 |
| 85 | 150 | 150 | 2 | 0.2 | 0.45455 |
| 86 | 150 | 150 | 0.2 | 2 | 0.45455 |
| | 200 ≤ Vc ≤ | 200 ≤ Vc ≤ | | | |
| | 300 | 300 | | | |
| 87 | 250 | 250 | 2000 | 2000 | 0.00025 |
| 88 | 250 | 250 | 2000 | 200 | 0.00045 |
| 89 | 250 | 250 | 200 | 2000 | 0.00045 |
| 90 | 250 | 250 | 200 | 200 | 0.0025 |
| 91 | 250 | 250 | 200 | 20 | 0.00455 |
| 92 | 250 | 250 | 20 | 200 | 0.00455 |
| 93 | 250 | 250 | 20 | 20 | 0.025 |
| 94 | 250 | 250 | 20 | 2 | 0.04545 |
| 95 | 250 | 250 | 2 | 20 | 0.04545 |
| 96 | 250 | 250 | 2 | 2 | 0.25 |
| 97 | 250 | 250 | 2 | 0.2 | 0.45455 |
| 98 | 250 | 250 | 0.2 | 2 | 0.45455 |

1. An electrocatalytic device for the production of dry hydrogen peroxide (DHP) comprising:
a) an electrocatalytic mesh (ECM) comprising an air permeable electrically conductive network coated with a catalyst;
b) an electrical power source including a variable waveform generator.

2. The device of claim 1, wherein said variable waveform generator is configured to provide a wave having a minimum voltage of ±0.3 V, a maximum voltage of 30 kilovolts (KV), and a frequency between 0.00025 Hertz (Hz) and 5 gigahertz (GHz).

3. The device of claim 1, wherein said variable waveform generator is a 555 timer integrated circuit. an ICL8038 circuit, or similar circuit.

4. The device of claim 1, wherein the current is between 0.01 Amp (A) and 100 A.

5. The device of claim 1, wherein said electrically conductive network is a coated copper mesh.

6. The device of claim 5, wherein said coated copper mesh comprises a zinc coating.

7. The device of claim 6, wherein said coated copper mesh further comprises a titanium dioxide.

8. The device of claim 1, wherein said electrically conductive network is a coated aluminum mesh.

9. The device of claim 5, wherein said coated aluminum mesh comprises a zinc coating.

10. The device of claim 6, wherein said coated aluminum mesh further comprises a titanium dioxide.

11. The device of claim 1, wherein said electrically conductive network is an air permeable conductive network comprising a meshwork or a conductive fabric having a nominal hole size ranging from 0.030 millimeters to 2.4 millimeters.

12. The device of claim 1, wherein said catalyst is a titanium dioxide in the form of anatase or rutile.

13. The device of claim 12, wherein said titanium dioxide is between 0.1% and 30% rutile.

14. The device of claim 1, further comprising an air distribution mechanism.

15. The device of claim 1, further comprising a filter or filter system.

16. A method of preparing a dry hydrogen peroxide (DHP) gas containing environment using an electrocatalytic device comprising:
providing an electrocatalytic device comprising an electrocatalytic mesh (ECM) comprising an air permeable electrically conductive network coated with a catalyst, and an electrical power source including a variable waveform generator;
providing a time varied electric potential to said ECM,
wherein said time varied electric potential has a waveform selected from the group consisting of sine wave, square wave, triangle wave, a sawtooth wave, and a combination thereof;
providing a flow of humid air through said electrically conductive network having a time varied electric potential to prepare a DHP containing airflow;
directing said DHP containing airflow into an enclosed environment.

17. The method of 14, wherein said time varied electrical potential has a minimum voltage of ±0.3 V, a maximum voltage of ±30 kilovolts (KV), and a frequency between 0.00025 Hertz (Hz) and 0.5 gigahertz (GHz).

18. The method of claim 17, wherein the current is between 0.01 Amp (A) and 100 A.

19. The method of claim 14, wherein said waveform has period that is the sum of the time in seconds of the power having a negative potential (τₐ) and a positive potential (τ_{c}).

20. The method of claim 14, wherein said waveform is symmetric.

21. The method of claim 14, wherein said waveform is asymmetric.

22. The method of claim 14, wherein the waveform is a square wave having an amplitude of ±10 volts and a pulse width of τₐ or τ_{c} and a period of τₐ+τ_{c}. variable duty cycle; dead band time;

23. The method of claim 14, wherein the square wave has a pulse width of τₐ or τ_{c} and a period of τₐ+τ_{c}, and where τₐ does not equal τ_{c}.

24. The method of claim 23, wherein τₐ is greater than τ_{c}.

25. The method of claim 24, wherein τₐ is between 60 seconds and 30 minutes.

26. The method of claim 23, wherein τₐ and τ_{c} are selected from the values of Table 8.

27. The method of claim 14, wherein said environment accumulates DHP at a level of between 1 part-per-billion (ppb) and 200 ppb.
